(19) United States
(12) Patent Application Publication
(10) Pub. No.: US 2014/0275475 A1
(43) Pub. Date: Sep. 18, 2014

(54) SEMIBATCHWISE PROCESS FOR PREPARING OLEFIN-CO COPOLYMERS

(71) Applicant: Bayer Intellectual Property GmbH, Monheim (DE)

(72) Inventors: Thomas Ernst Müller, Aachen (DE); Christoph Gürtler, Koln (DE); Walter Leitner, Aachen (DE); Henning Vogt, Aachen (DE); Saeeda Soomro, Kassel (DE)

(73) Assignee: Bayer Intellectual Property GmbH, Monheim (DE)

(21) Appl. No.: 14/203,867

(22) Filed: Mar. 11, 2014

(30) Foreign Application Priority Data
Mar. 12, 2013 (EP) 13158810.5

(51) Int. Cl. C08G 67/02; C08G 73/02; C08G 71/04; C08G 65/00

(52) U.S. Cl. CPC C08G 67/02; C08G 65/00; C08G 73/02; C08G 71/04; C08G 73/024
USPC 528/392; 568/672; 564/472; 528/220; 528/425; 528/422; 564/512; 564/504

(57) ABSTRACT

A process for preparing olefin-CO copolymers with the steps of:
providing a reactor;
charging the reactor with a gaseous olefin and with CO, such that there is a first pressure p1 in the reactor; and
reacting olefin with CO in the presence of a catalyst in the reactor.

Prior to the reaction, either no CO is present in the reactor or the volume ratio of gaseous olefin to CO is ≧90:10. During the reaction, gaseous olefin and CO are metered in at least intermittently, with an average over time of the volume ratio of the olefin metered into CO metered in of ≧90:10.

### FIELD OF THE INVENTION

The present invention relates to a specific process for preparing olefin-CO copolymers in the presence of a catalyst, wherein olefin and CO are metered into the copolymerization reaction during the course of the reaction. This invention further provides olefin-CO copolymers which are obtained by this process, and for the use thereof as polymer additives or crosslinkers, in powder coatings, as binders or, after reduction or reductive amination, as crosslinkers for polyurethanes.

This invention further provides polyalcohols and polyamines, or polyamine-polyalcohols, which are obtainable from the inventive olefin-CO copolymers, and for the use thereof as polymer additives and/or for preparation of polyurethane and/or polyurea polymers.

### BACKGROUND OF THE INVENTION

Olefin-CO copolymers (also referred to interchangeably in the context of the invention as “polyketones”) are usable in various ways, for example as plasticizers for PVC or as crosslinkers. In the case of the latter, the carbonyl group reacts with CH-acidic compounds in aldol reactions or with amines or hydrazine derivatives to give azomethines. CH-acidic groups adjacent to the carbonyl group can also react with other carbonyl components.

Under reductive conditions, for example through hydrogenation with hydrogen over heterogeneous metal catalysts, it is possible to obtain, from the olefin-CO copolymers, polyalcohols which likewise find various uses, for example as PVC plasticizers, or as crosslinkers for polyurethanes.

In addition, through reaction with hydroxylamine or ammonia and subsequent reduction, for example hydrogenation with hydrogen over heterogeneous metal catalysts, it is possible to obtain polyamines which can themselves serve as crosslinkers for polyurethanes.

For all applications, a low density of carbonyl groups within the polymer chain is desirable for various reasons. This density can be expressed by the molar CO content in the molecule. At a CO content of close to 50 mol %, a very substantially alternating olefin-CO copolymer is present. Alternating olefin-CO copolymers having a CO content of 50 mol % have a high melting point of about 257° C. This requires processing temperatures exceeding 280° C., where decomposition phenomena and/or discolouration typically occur (see EP 0 213 671). At a high CO content, there is an increased probability that aldol reactions will occur to an enhanced degree at high temperatures and/or under chemical influence, these leading to crosslinking of the polymer. Under the action of oxygen and/or UV irradiation, enhanced degradation of the polymer chains occurs in the case of olefin-CO copolymers having a high CO content. For this reason, the CO content in olefin-CO copolymers for the abovementioned applications should be below 5 mol %.

Moreover, a high CO content promotes increased occurrence of “alternating” units of the structure —CO—C₂H₄₋ₙRₙ—CO—. In this context, “alternating” means that only one alkenyl unit C₂H₄₋ₙRₙ is present between two CO groups in the polymer chain, where n≧1 and ≦4 and R denotes hydrogen or alkyl radicals, and different R may differ within one C₂H₄₋ₙRₙ unit and between different C₂H₄₋ₙRₙ units, and/or two or more R within one C₂H₄₋ₙRₙ unit are joined to one another so as to form bi-, tri- or polycyclic systems. The content of alternating units may be expressed by the “alternating fraction”, i.e. the molar fraction of —CO—C₂H₄₋ₙRₙ—CO— fragments in which exactly one C₂H₄₋ₙRₙ alkenyl unit is bonded to a CO group on each side, based on the total amount of all CO—(C₂H₄₋ₙRₙ)ₓ—CO and CO—(C₂H₄₋ₙRₙ)_{y}-EG fragments, where x, y≧1 and EG is an end group. This “alternating fraction” can be expressed by the proportion of carbon atoms bonded directly to a CO group within alternating —CO—C₂H₄₋ₙR—CO— fragments in the total amount of all carbon atoms bonded directly to a CO group. This “alternating fraction” can be determined, for example, by NMR spectroscopy.

Alternating CO—C₂H₄₋ₙR—CO— fragments, in the catalytic hydrogenation, lead readily to cyclic oxolane units which lower the hydroxyl functionality of the product and facilitate chain degradation. Similarly, the alternating CO—C₂H₄₋ₙRₙ—CO— units, in the reductive amination, lead to cyclic pyrrolidine units and thus have an adverse effect on the ratio of primary to secondary amines, which should be at a maximum for applications in the polyurethane sector. For these reasons, the proportion of alternating CO—C₂H₄₋ₙRₙ—CO— fragments (alternating fraction) should be at a minimum.

For applications in the polyurethane sector, for example as a crosslinker after hydrogenation to give the corresponding polyalcohol or after reductive amination to give the corresponding polyamine or polyamine-polyalcohol, a number-average molecular weight≦15 000 g/mol would additionally be desirable.

In addition, a low semicrystallinity would be desirable for the abovementioned applications in order to ensure adequate reactivity of the carbonyl groups present in the polymer chain.

EP 0 632 084 describes a catalytic batchwise process in which, using a catalyst which has been generated in situ from palladium acetate and a phosphine-sulphonate ligand, incompletely alternating olefin-CO copolymers are obtained. “Batchwise process” means that the copolymerization is conducted without metered addition of reactants, especially ethylene and/or CO, into the running reaction. The highest turnover frequency (TOF, expressed in g of polymer obtained per mmol of catalyst per hour) is 3.5 g/(mmol_{Pd}×h). The lowest CO content in an ethylene-CO copolymer was listed as 42.5 mol % of CO. Thus, the non-alternating fraction is not more than 15 mol % and the alternating fraction is not less than 85 mol %. The corresponding product has a melting point of 210° C. No statement is made as to the molecular weight.

Chem. Commun. 2002, 964 describes a batchwise process in which, in the presence of the same catalyst, ethylene-CO copolymers having a CO content of at least 40.85 mol % of CO were obtained. Thus, the non-alternating fraction is not more than 18.3 mol % and the alternating fraction is not less than 81.7 mol %. The TOF in this case was 108 g/(mmol_{Pd}×h). The highest TOF at 190 g/(mmol_{Pd}×h) was attained for an ethylene-CO copolymer having 48.8 mol % of CO. All the products obtained have molecular weights of ≧30 000 g/mol.

Organometallics 2009(24), 6994 describes a batchwise process based on the same catalyst, in which ethylene-CO copolymers having CO contents between 6 and 32 mol % were obtained. Even though FIG. 3 includes a polymer having 1 mol % of CO, this is described neither in the text nor in the supporting information. Nor are any more exact details given with regard to the alternating fraction for the described products having a CO content≧6 mol %. The highest TOF is 4.94 g/(mmol_{Pd}×h). For an ethylene-CO copolymer having a CO content of 10 mol %, a number-average molecular weight of 4460 g/mol was measured by GPC against polystyrene standards. Since the turnover number (TON) in this example is 3270 g/mol_{Pd}, it can be assumed that the low molecular weight results from the low TON and molecular weight control is impossible at higher conversions.

Ethylene-CO copolymers having a CO content below 5 mol % and an alternating fraction below 32.5% are unobtainable by the processes described above. It is additionally apparent from the comparison of the results described in the literature cited above that, when the palladium catalyst generated in situ is used in a batchwise process, lowering of the CO content in ethylene-CO copolymers is accompanied by lowering of the TOF. For ethylene-CO copolymers having a CO content≦5 mol %, further lowering of the TOF to a value of <4.94 g/(mmol_{Pd}×h) would therefore be expected in this process. Because of the low TOFs, these processes are therefore unattractive for industrial use.

The use of an isolated complex catalyst for preparation of ethylene-CO copolymers having a CO content of at least 35.2 mol % is described in Organometallics 2005(24), 2755. Thus, the non-alternating fraction is not more than 29.2 mol % and the alternating fraction is not less than 70.4 mol %. The corresponding product was obtained with a TOF of 134 g/(mmol_{Pd}×h). The highest TOF at 292 g/(mmol_{Pd}×h) was attained for an ethylene-CO copolymer having 48.45 mol % of CO. For an ethylene-CO polymer containing 36.8 mol % of CO, after fractionation by GPC against PMMA standards, a number-average molecular weight of ≧300 000 g/mol was determined.

By the process described here too, ethylene-CO copolymers having a CO content below 5 mol % and an alternating fraction below 32.5% are unobtainable. The comparison of the results achieved shows that, here too, lowering of the CO content in ethylene-CO copolymers is accompanied by lowering of the TOF. The molecular weights obtained have significant variations and are typically ≧15 000 g/mol.

Olefin-CO copolymers which have been obtained by free-radical polymerization are described, for example, in U.S. Pat. No. 2,495,286, GB 1522942, US 2008/0242895 inter alia. However, the person skilled in the art is aware that the copolymers obtained by a free-radical route, because of a higher level of branching, are fundamentally different in structural terms from the predominantly linear olefin-CO copolymers obtained by a catalytic route in this invention. The level of branching can be determined, for example, by NMR spectroscopy and reported as the average number of branching (i.e. at least trisubstituted) carbon atoms per 1000 carbon atoms present in the polymer. The person skilled in the art is aware that an increased level of branching leads to increased melt viscosities and hence complicates processing in the molten state. For the applications mentioned at the outset, olefin-CO copolymers having a low level of branching would therefore be desirable.

Furthermore, the use of potentially explosive free-radical initiators in free-radical polymerization processes entails increased precautionary measures, which complicate industrial application.

It is apparent from the publications cited above that there is no known catalytic process with which olefin-CO copolymers having a CO content below 5 mol % and an alternating fraction below 32.5 mol % can be obtained. The problem addressed by the present invention is therefore that of providing such a process.

### Embodiments of the Invention

An embodiment of the present invention is a process for preparing an olefin-CO copolymer, comprising the steps of:
providing a reactor;
charging the reactor with a gaseous olefin and with CO, such that there is a first pressure p1 in the reactor;
reacting olefin with CO in the presence of a catalyst in the reactor;
   wherein
   prior to the reaction either no CO is present in the reactor or the volume ratio of gaseous olefin to CO is ≧90:10
   and gaseous olefin and CO are metered in at least intermittently during the reaction, with an average over time of the volume ratio of the gaseous olefin metered in to CO metered in of ≧90:10.

Another embodiment of the present invention is the above process, wherein the pressure in the reactor during the reaction is in the range from ≧80% of p1 to ≦120% of p1.

Another embodiment of the present invention is the above process, wherein a pressure drop which occurs during the reaction is balanced out by feeding further gaseous olefin and CO into the reactor, and wherein the average over time of the volume ratio of the further gaseous olefin fed in to the further CO fed in is ≧90:10.

Another embodiment of the present invention is the above process, wherein the catalyst comprises palladium.

Another embodiment of the present invention is the above process, wherein the catalyst comprises an anionic bidentate ligand comprising a phosphorus atom bridged by an oxygen anion over at least two and a maximum of four further atoms.

Another embodiment of the present invention is the above process, wherein the reaction of the olefin with CO takes place in the presence of a further olefin.

Another embodiment of the present invention is the above process, wherein the reaction of the olefin with CO is preceded by a homopolymerization of the olefin or a copolymerization of a plurality of olefins in the reactor.

Another embodiment of the present invention is the above process, wherein the pressure p1 is ≧20 bar to ≦300 bar.

Another embodiment of the present invention is the above process, wherein the reaction is performed at a temperature of ≧90° C. to ≦150° C.

Another embodiment of the present invention is the above process, wherein the catalyst is injected at a temperature of ≧90° C. to ≦150° C. into the reactor containing gaseous olefin or a mixture of gaseous olefin and CO.

Yet another embodiment of the present invention is an olefin-CO copolymer obtained by the above process, wherein the content of CO incorporated into the polymer is ≦5 mol % based on all the monomers incorporated and the copolymer has an alternating fraction of ≦32.5 mol %.

Another embodiment of the present invention is the olefin-CO copolymer above having a number-average molecular weight Mₙ of ≦15 000 g/mol.

Yet another embodiment of the present invention is a polyol compound obtained by reducing the olefin-CO copolymer above.

Another embodiment of the present invention is a polyamine and/or polyamine-polyalcohol compound obtained by reductively aminating the olefin-CO copolymer above.

Yet another embodiment of the present invention is a method for the preparation of a polyurethane and/or polyurea polymer comprising utilizing the olefin-CO copolymer above.

Yet another embodiment of the present invention is a method comprising utilizing the olefin-CO copolymer above as polymer additive.

Yet another embodiment of the present invention is a method for the preparation of a polyurethane and/or polyurea polymer comprising utilizing the polyol compound above.

Yet another embodiment of the present invention is a method comprising utilizing the polyol compound above as polymer additive.

Yet another embodiment of the present invention is a method for the preparation of a polyurethane and/or polyurea polymer comprising utilizing the polyamine and/or polyamine-polyalcohol compound above.

Yet another embodiment of the present invention is a method comprising utilizing the polyamine and/or polyamine-polyalcohol compound above as polymer additive.

### DETAILED DESCRIPTION OF THE INVENTION

This problem is solved in accordance with the invention by a process for preparing olefin-CO copolymers, comprising the steps of:
providing a reactor;
charging the reactor with a gaseous olefin and with CO, such that there is a first pressure p1 in the reactor;
reacting olefin with CO in the presence of a catalyst in the reactor;
   prior to the reaction either no CO is present in the reactor or the volume ratio of gaseous olefin to CO is ≧90:10, and gaseous olefin and CO are metered in at least intermittently during the reaction, with an average over time of the volume ratio of the gaseous olefin metered in to CO metered in of ≧90:10.

Under the reaction conditions used in the process according to the invention, the volume ratio of gaseous olefin:CO can be equated to the partial pressure ratio of gaseous olefin:CO. Therefore, the partial pressure ratio can also be considered analogously instead of the volume ratio.

This process allows provision of the desired olefin-CO copolymers in a TOF satisfactory for industrial applications. In the performance of the copolymerization of olefins with CO by the process according to the invention, higher TOFs are achieved than in the performance under otherwise identical reaction conditions in a batchwise process, i.e. without the metered addition of gaseous olefin and CO during the reaction.

According to the invention, prior to the reaction, either gaseous olefin in the absence of CO is present in the reactor or the volume ratio of gaseous olefin to CO is ≧90:10. Preferably, this ratio is within a range from ≧90:10 to ≦99.5:0.5, more preferably ≧90:10 to ≦98:2. The same considerations apply to the average values over time for the volume ratios of the olefin metered in during the reaction to CO metered in.

Without being tied to a theory, it is assumed that the copolymerization of an ethylene-CO mixture in an ethylene:CO volume ratio of ≧90:10 in the presence of a palladium catalyst having a bidentate phosphine-sulphonate ligand (model system) runs through at least two reaction phases having different reaction rates. Accordingly, in a first phase (alternating phase) with low reaction rate, a predominantly alternating ethylene-CO copolymer having an ethylene:CO composition close to 1:1 is formed, before, in a later phase (non-alternating phase) with a higher reaction rate, a predominantly non-alternating ethylene-CO copolymer having an ethylene:CO ratio≧1:1 is formed. The result of this is that, in the copolymerization of ethylene and CO in a batchwise process, i.e. without metered addition of ethylene and CO in the course of the reaction, a large portion of the available CO is incorporated into alternating units during the formation of the alternating ethylene-CO copolymers in the alternating phase, such that a predominantly ethylene-containing polymer is formed in the subsequent non-alternating phase. Therefore, an undesirably high molar proportion of alternating CO—C₂H₄—CO— fragments is present, based on the total amount of all CO—(C₂H₄)ₓ—CO and CO—(C₂H₄)_{y}-EG fragments.

Olefin-CO copolymers in the context of the invention refer to polymers which arise from the copolymerization of at least one olefin with carbon monoxide (CO) by the process according to the invention.

The polymer chains of the inventive olefin-CO copolymers contain at least one —CO—(C₂H₄₋ₙRₙ)ₓCO— fragment where x≧2, n≧1 and n≦4, and R, depending on the olefin used or the olefin mixture used, denotes hydrogen or a linear or branched, saturated or mono- or polyunsaturated C1- to C20-alkyl radical which may additionally contain one or more heteroatoms, especially oxygen, nitrogen, sulphur, silicon and/or phosphorus, and different R may differ within one C₂H₄₋ₙRₙ unit and between different C₂H₄₋ₙRₙ units and/or different R within one C₂R₄₋ₙRₙ unit are joined to one another such that they form bi-, tri- or polycyclic systems. As well as the CO—(C₂H₄₋ₙRₙ)ₓ—CO fragments, the polymer chain may contain CO—(C₂H₄₋ₙRₙ)ₗ—CO fragments where n and R correspond to the abovementioned definitions. Different CO—(C₂H₄₋ₙRₙ)ₓ—CO and/or CO—(C₂H₄₋ₙRₙ)ₗ—CO fragments may be joined via a common CO group and hence share a CO group. In the case of presence of CO—(C₂H₄₋ₙRₙ)ₗ—CO fragments, the alternating fraction, i.e. the molar proportion of CO—(C₂H₄₋ₙRₙ)ₗ—CO— fragments, is ≦32.5 mol % based on the total amount of all CO—(C₂H₄₋ₙRₙ)ₓ—CO and CO—(C₂H₄₋ₙ)_{y}-EG fragments, where y≧1 and EG is an end group.

As well as the branches in the polymer chain caused by the presence of the olefin radicals R in C₂H₄₋ₙRₙ units, additional short-chain branches —CH(CH₃₋ₘRₘ)— or —CR(CH₃₋ₘRₘ)— may occur in the polymer chain, where m=0, 1 or 2 and R is as defined above.

As end groups (EG), the inventive olefin-CO copolymers contain, for example, carboxyl groups, formyl groups, linear or branched, saturated or mono- or polyunsaturated C1- to C20-alkyl or cycloalkyl radicals which may additionally contain one or more heteroatoms, especially oxygen, nitrogen, sulphur, silicon and/or phosphorus, ester groups —OC(O)R′ or ether groups —O—R′, where R′ is a linear or branched, saturated or mono- or polyunsaturated C1- to C20-alkyl or cycloalkyl radical which may additionally contain one or more heteroatoms, especially oxygen, nitrogen and/or sulphur, though this enumeration should not be considered to be exclusive. Examples of end groups present in the inventive olefin-CO copolymers are especially acetate —OC(O)CH₃, methoxy —OCH₃, methyl —CH₃, ethyl —CH₂CH₃, ethylene —CH═CH₂, 1-propylene —CH═CH—CH₃, 1-methylpropyl-2-ene —CH(CH₃)—CH═CH₂, 6-alkoxy-exo-5,6-dihydrodicyclopentadienyl, 2-alkoxycyclooct-5-enyl, where the alkoxy groups are derived from a linear or branched C1- to C20-alkyl radical.

Preferably, the inventive olefin-CO copolymers have a number-average molecular weight of ≦15 000 g/mol. The molecular weight can be determined, for example, by gel permeation chromatography or NMR spectroscopy.

With regard to the reactor, any reaction vessel designed for the pressures and temperatures which exist during the reaction is suitable in principle. Thus, the reactors may be stirred tank reactors, autoclaves and the like; in the case of a heterogeneous catalyst, the catalyst bed may be in a fixed bed, in a trickle bed or in a fluidized bed.

“Olefin” in the context of the invention denotes olefins C₂H₄₋ₙRₙ containing at least one C═C double bond, where n≧1 and ≦4 and R is a linear or branched, saturated or mono- or polyunsaturated C1- to C20-alkyl radical which may additionally contain one or more heteroatoms, especially oxygen, nitrogen, sulphur, silicon and/or phosphorus, and different R may differ within one olefin C₂H₄₋ₙRₙ and/or different R within one olefin C₂H₄₋ₙRₙ are joined to one another such that they form bi-, tri- or polycyclic systems. Examples of olefins are ethylene, propylene, 1-butene, 2-butene, isobutene, butadiene, 1-pentene, 1-hexene, 4-methyl-1-pentene, 1-heptene, 1-octene, isooctene, 1-nonene, 1-decene, cyclopentene, cyclopentadiene, cyclohexene, cyclooctene, cyclooctadiene, norbornene, styrene, 2-methylstyrene, 3-methylstyrene, 4-methylstyrene, α-methylstyrene, β-methylstyrene, 4-methoxystyrene. The term “olefin” in the context of the invention likewise relates to mixtures of two or more olefins in any composition.

Gaseous olefins in the context of the invention refer to olefins C₂H₄₋ₙRₙ in the sense of the invention which are in the gaseous or supercritical state under standard conditions (25° C., 1013 mbar). Examples of gaseous olefins are ethylene, propylene, 1-butene, 2-butene, isobutene and butadiene. The term “gaseous olefin” in the context of the invention likewise relates to mixtures of two or more gaseous olefins in any composition.

The reactor is charged, in the presence or absence of a suitable solvent, with a gaseous olefin or a mixture of gaseous olefins and CO, such that there is a first pressure p1 in the reactor, for example 20 to 300 bar, preferably 30 to 200 bar, more preferably 30 to 100 bar, and, when a mixture of gaseous olefin and CO is used, the volume ratio between gaseous olefin and CO is ≧90:10. The presence of an additional gas, for example hydrogen or an inert gas, for example nitrogen or argon, is not ruled out, although the condition that the volume ratio between gaseous olefin and CO is ≧90:10 remains fulfilled.

The solvents used for the reaction may be aprotic solvents, for example alkanes, cycloalkanes, aromatics, for example benzene, toluene, xylenes, mesitylen, chlorinated alkanes, for example dichloromethane, chloroform, dichloroethane, tetrachloroethane, chlorinated aromatics, for example chlorobenzene or dichlorobenzenes, open-chain or cyclic ethers, for example diethyl ether, methyl tert-butyl ether, tetrahydrofuran, 1,4-dioxane, polyethers, for example ethylene glycol dimethyl ether, diethylene glycol dimethyl ether or the higher homologues thereof, esters, for example ethyl acetate, cyclic carbonates, for example ethylene carbonate or propylene carbonate, open-chain or cyclic amides, for example N,N-dimethylformamide, N,N-dimethylacetamide, N-methylpyrrolidinone, or protic solvents such as alcohols, e.g. methanol, ethanol, isopropanol, diols, for example ethylene glycol, diethylene glycol and the higher homologues thereof, or water or mixtures of two or more of the aforementioned solvents in any desired composition. Preferred solvents are dichloromethane, methanol, tetrachloroethane, more preferably dichloromethane.

The copolymerization of the olefin with CO takes place in the presence of a catalyst. The catalysts used are, for example, compounds containing at least one metal atom selected from the elements iron, cobalt, nickel, ruthenium, rhodium and/or palladium. Preferred catalysts contain nickel or palladium, particularly preferred catalysts palladium.

When a solvent is used, the concentration of the catalyst based on the metal is generally 1×10⁻⁵ to 1×10⁻¹ mmol/l, preferably 1×10⁴ mmol/l to 5×10⁻² mmol/l and more preferably 5×10⁴ mmol/l to 1×10⁻² mmol/l.

The catalyst or a mixture of the catalyst components, i.e. metal salt or complex and ligand may be initially charged in the reactor either in pure form or together with a solvent and/or olefin, or be injected into the reactor in liquid or dissolved form during the heating of the reactor to reaction temperature or on attainment of the reaction temperature. In the case of injection, the injection can be effected either in the absence or presence of solvent and/or olefin. Irrespective of this, the reactor at the time of injection may contain olefin or a mixture of olefin and CO, the volume ratio of gaseous olefin and CO being ≧90:10. However, the injection can also be effected in the absence of olefin and CO. The presence of a further gas, for example hydrogen, nitrogen or argon, is not ruled out in any of the process variants mentioned.

In addition to the catalyst, it is possible to use further additives which, for example, promote activation and/or stabilization of the catalyst. Possible additives are enumerated, for example, in Dalton Trans. 2008, 4537. More particularly, these include methylaluminoxane (MAO), [CPh₃][B(C₆F₅)₄] and other tetraarylborate salts, B(C₆F₅)₃ and sulphonic acids, for example 4-toluenesulphonic acid. These additives can be introduced into the reaction mixture either in a mixture with the catalyst or separately, prior to or after addition of the catalyst.

With regard to the reaction conditions, the reaction is generally initiated when the catalyst is in contact with the olefin and CO at a temperature of about ≧90° C. and ≦150° C.

During the copolymerization reaction, gaseous olefin and CO and optionally further olefin are metered into the reactor at least intermittently, such that the average over time of the volume ratio of gaseous olefin and CO metered in is ≧90:10. This can be effected by continuous metered addition of the separate gaseous components, gaseous olefin and CO, in a volume flow ratio of ≧90:10, or of a mixture of gaseous olefin and CO in a volume ratio of ≧90:10. Alternatively, alternating or simultaneous metered addition of separate volumes of gaseous olefin and CO can be effected in a volume ratio averaged over time of gaseous olefin:CO≧90:10 or pulsed metered addition of a mixture of gaseous olefin and CO in a volume ratio of ≧90:10. Preference is given to the continuous metered addition of the separate gaseous components or of a mixture.

The metered addition is performed in such a way that the pressure in the reactor during the copolymerization is, for example, between 20 and 300 bar, preferably between 30 and 200 bar, more preferably between 30 and 100 bar.

The metering can be effected manually by continuous or repeated pulsed setting of the pressure with the gases to be metered in, observing a volume ratio averaged over time of gaseous olefin:CO≧90:10. Preference is given to metered addition with the aid of mass flow regulators or Cori-Flow regulators which are connected to a digital pressure sensor and compensate differentially for the pressure drop which occurs during the reaction by metered addition of gaseous olefin and CO in a volume flow ratio of gaseous olefin:CO≧90:10, or of a mixture of gaseous olefin and CO in a volume ratio of gaseous olefin:CO≧90:10.

The reaction temperature during the copolymerization is generally ≧90° C. and ≦150° C. The temperature can be set by external and/or internal heating of the reactor. Preference is given to regulating the reaction temperature via the internal reactor temperature. Because of the potential exothermicity of the reaction, additional protection from overheating of the reactor and of the reaction mixture by counter-cooling is advantageous. This can be effected by cooling the outer reactor wall and/or preferably by means of appropriate internals, for example a cooling coil, within the reactor. The counter-cooling is preferably integrated into the temperature control system.

The reaction time in the copolymerization can be selected freely. If a process variant in which the catalyst is contacted directly with a mixture of gaseous olefin and CO at a temperature of about ≧90° C. and ≦150° C. without prior contact with the gaseous olefin in the absence of CO is selected, the reaction time is longer than the duration of the alternating phase at the start of the copolymerization. This can be determined, for example, by monitoring the conversion of gaseous olefin and CO. If, for example, in the case of a palladium-catalysed reaction, the conversion per minute increases within 5 minutes by a factor of greater than or equal to 1.1 and, in absolute terms, is greater than 1.5 g/(mmol_{Pd}·min), the alternating phase can be considered to be complete. Depending on the process variant selected, the conversion can be monitored, for example, by determining the pressure drop during the reaction and/or the volumes of the gases supplied as a function of time. The maximum reaction time is limited merely by technical factors, for example reactor volume, stirrability and/or mass transfer.

The copolymerization can be ended by cooling the reactor to a temperature below 90° C., preferably 40° C., and/or releasing the excess pressure. Additionally or alternatively, reagents which deactivate the catalyst can be added. Examples of these which can be used include water, ammonia, primary or secondary amines, diols or mixtures thereof, in a composition to be selected freely.

For isolation of the olefin-CO copolymers, solvents and/or unreacted olefins, if present, are removed after the excess pressure has been released. This can be effected by filtering and optionally washing the solid obtained with one or more of the abovementioned solvents. Alternatively or additionally, volatile components can be removed by distillation thereafter. This can be effected at temperatures between 20° C. and 90° C. (inclusive), and optionally at a reduced pressure≧1×10⁻³ mbar and <1013 mbar. Further purification steps, for example melt crystallization, precipitation or recrystallization from a solution of the copolymer in suitable solvents, optionally at elevated temperatures up to 120° C., or thin-film evaporation may follow, but are not absolutely necessary.

Further embodiments of the present invention are described hereinafter. They can be combined with one another as desired, unless the opposite is absolutely clear from the context.

In one embodiment, the reactor containing the catalyst or the catalyst components is charged with a mixture comprising olefin and CO to a pressure p≦p1, the volume ratio of gaseous olefin:CO being ≧90:10. The reactor is subsequently heated to reaction temperature, attaining the pressure p1 in the reactor. The copolymerization reaction commences, for example, when a temperature of about 90° C. is exceeded.

In a further embodiment, the reactor containing the catalyst or the catalyst components is heated to reaction temperature and the reactor is charged at reaction temperature with a mixture comprising olefin and CO to a pressure p1, the volume ratio of gaseous olefin:CO being ≧90:10. In that case, the copolymerization reaction generally commences with the charging of the reactor.

In a preferred embodiment, the reactor containing a mixture of olefin and CO, where the volume ratio of gaseous olefin:CO is ≧90:10, is heated to reaction temperature at a pressure p<p1, attaining a pressure p′<p1 on attainment of the reaction temperature in the reactor. On attainment of the reaction temperature, the catalyst or a mixture of the catalyst components is injected, the pressure p1 being attained and the copolymerization commencing with the injection.

In one embodiment of the process according to the invention, the pressure in the reactor during the reaction is in the range from ≧80% of p1 to ≦120% of p1, preferably ≧90% of p1 to ≦110% of p1, more preferably ≧95% of p1 to ≦105% of p1.

In a further embodiment of the process according to the invention, the pressure drop which occurs during the reaction is balanced out by feeding further gaseous olefin and CO into the reactor, the average over time of the volume ratio of the further gaseous olefin fed in to the further CO fed in being ≧90:10.

In a further embodiment of the process according to the invention, the catalyst comprises palladium.

In a further embodiment, a catalyst containing an anionic bidentate ligand containing a phosphorus atom bridged to an oxygen anion over at least two and a maximum of four further atoms is used. More preferably, in the case of this ligand, palladium is the central metal in the complexes thereof. The oxygen anion is preferably in the form of a sulphonate group. The bridge to the oxygen anion preferably contains a C═C double bond, which is more preferably part of an aromatic system. The phosphorus atom is preferably in the oxidation state of 3 and bears two further alkyl or aryl substituents as well as the bridging substituent. More preferably, the phosphorus atom bears two ortho-alkoxy-substituted aryl groups as substituents as well as the bridging substituent. Very particularly preferred ligands are phosphine-sulphonate ligands of the formula I

[chemical structure]

where
R″ is a linear or branched, saturated or mono- or polyunsaturated C1- to C20-alkyl or aryl radical which may additionally contain one or more heteroatoms, especially oxygen, nitrogen, sulphur and/or phosphorus,
and X and Y are each independently hydrogen or one or more linear or branched, saturated or mono- or polyunsaturated C1- to C20-alkyl, -aryl, -alkylaryl, -arylalkyl, -alkyloxy, aryloxy, -alkylaryloxy or -arylalkoxy radical which may additionally contain one or more heteroatoms, especially oxygen, nitrogen, sulphur and/or phosphorus.

Further substituents on the aromatic ring systems, for example further linear or branched, saturated or mono- or polyunsaturated, optionally mono- or polyfluorinated C1- to C20-alkyl, -aryl, -alkylaryl, arylalkyl, -alkyloxy, -aryloxy, -alkylaryloxy or -arylalkoxy radicals, halogen atoms, especially chlorine or fluorine, nitro groups and/or sulpho groups, are not ruled out. In addition, the aromatic rings may independently be part of a bi-, tri-, tetracyclic or higher ring system.

In a preferred embodiment, a complex containing palladium and the ligand in a molar ratio of 1:1 is used. Preferred complex catalysts are Pd(L̂L′)(P̂O) where P̂O is a ligand of the formula I and L̂L′ is 2-alkoxycyclooct-5-enyl or 6-alkoxy-exo-5,6-dihydrodicyclopentadienyl, where the alkoxy groups are derived from linear or branched C1- to C20-alkyl radicals. More preferably, for the ligands P̂O of the formula I, R″=CH₃, X=H and Y=H or CH₃ and for L̂L′, the alkoxy groups are methoxy or ethoxy groups.

In a further embodiment of the process according to the invention, the catalyst is formed in situ in the reactor from precursor compounds. In a preferred embodiment, the catalyst is generated before the reaction or in situ by mixing a metal salt or complex with the ligand in protonated or deprotonated form in a molar metal:ligand ratio of 1:0.5 to 1:5, preferably 1:0.8 to 1:2, more preferably 1:1 to 1:1.5, in a suitable solvent from the abovementioned selection. Preferred metal salts or complexes are nickel or palladium salts or complexes, for example Ni(acac)₂, Ni(cod)₂, [Ni(allyl)Cl]₂, [Ni(allyl)Br]₂, Ni(PPh₃)PhCl, Ni(dme)Br, Pd(OAc)₂, [Pd(allyl)Cl]₂, [Pd(allyl)Br]₂, PdMeCl(cod), [Pd(codyl)Cl]₂, [Pd(cpdOEt)Cl]₂, more preferably Pd(OAc)₂, [Pd(L̂L)Cl]₂ (where acac=acetylacetonate, cod=1,5-cyclooctadiene, dme=dimethoxyethane and L̂L is as defined above).

In a further embodiment of the process according to the invention, the reaction of the olefin with CO takes place in the presence of a further (liquid) olefin which does not form part of the group of gaseous olefins. For example, additionally or alternatively to the solvent, it is possible to initially charge the reactor with a (liquid) olefin C₂H₄₋ₙRₙ or a mixture of two or more (liquid) olefins C₂H₄₋ₙRₙ, where n and R are each as defined above. Suitable (liquid) olefins are, for example, 1-pentene, 1-hexene, 4-methyl-1-pentene, 1-heptene, 1-octene, isooctene, 1-nonene, 1-decene, styrene, 2-methylstyrene, 3-methylstyrene, 4-methylstyrene, α-methylstyrene, β-methylstyrene, 4-methoxystyrene. Preferred liquid olefins are 1-hexene, 4-methyl-2-pentene, 1-octene, isooctene, styrene, α-methylstyrene, more preferably 1-hexene and styrene.

In a further embodiment, the further (liquid) olefin can be metered into the reactor during the reaction. The two latter embodiments are not mutually exclusive. For instance, a particular proportion of the further (liquid) olefin can be initially charged in the reactor prior to the reaction, and the remaining amount of further (liquid) olefin can be metered in during the reaction.

The further (liquid) olefins can be incorporated into the polymer chain during the copolymerization and, in this case, are likewise present therein as the C₂R₄₋ₙRₙ unit in CO—(C₂H₄₋ₙRₙ)ₗ—CO, CO—(C₂H₄₋ₙRₙ)ₓ—CO or CO—(C₂H₄₋ₙRₙ)_{y}-EG polymer fragments.

In a further embodiment, the reaction of the olefin with CO is preceded by a homopolymerization of the olefin or a copolymerization of a plurality of olefins in the reactor. This embodiment offers the advantage that the alternating phase with low reaction rate on commencement of the copolymerization reaction is avoided. This leads to a high turnover frequency (TOF), expressed in g_{product}/(mmol_{Pd}×h), compared to process variants in which the copolymerization of olefin and CO is conducted without prior homopolymerization of the olefin or copolymerization of a plurality of olefins in the reactor. In addition, this embodiment offers the advantage that the alternating fraction in the olefin-CO copolymer obtained is lowered.

In one embodiment, the reactor containing the catalyst or the catalyst components and optionally further (liquid) olefin is charged with gaseous olefin in the absence of CO to a pressure p≦p1. The reactor is subsequently heated to reaction temperature, attaining the pressure p1 in the reactor. When a temperature of about 90° C. is exceeded, the homopolymerization of the olefin or the copolymerization of the gaseous olefin and the further (liquid) olefin commences. The copolymerization with CO is initiated by metered addition of gaseous olefin and CO in a volume ratio averaged over time of gaseous olefin:CO≧90:10. The metered addition of gaseous olefin and CO can be effected directly after the commencement of the homopolymerization of the gaseous olefin or of the copolymerization of gaseous olefin and further (liquid) olefin, or with a time delay.

In a preferred embodiment, the reactor containing gaseous olefin and optionally further (liquid) olefin is heated to reaction temperature in the absence of CO, attaining a pressure p′<p1 in the reactor on attainment of the reaction temperature. On attainment of the reaction temperature, the catalyst is injected, in which case the pressure p1 is attained with the injection and the homopolymerization of the gaseous olefin or the copolymerization of the gaseous olefin and the further (liquid) olefin commences. The copolymerization with CO is initiated by metered addition of gaseous olefin and CO in a volume ratio averaged over time of gaseous olefin:CO≧90:10. The metered addition of gaseous olefin and CO can be effected directly after the commencement of the homopolymerization of the gaseous olefin or of the copolymerization of gaseous olefin and further (liquid) olefin, or with a time delay.

Alternatively, the catalyst or a mixture of the catalyst components can be injected into the reactor containing gaseous olefin and optionally further (liquid) olefin with the aid of a mixture of gaseous olefin and CO in a volume ratio of gaseous olefin:CO≧90:10. Because of the negligible CO content in the reactor at the time of injection, the injection initiates homopolymerization of the gaseous olefin, and this becomes a copolymerization on further metered addition of the mixture of gaseous olefin and CO.

In a further embodiment of the process according to the invention, the pressure p1 is ≧20 bar to ≦300 bar. Preferred pressures are ≧25 to ≦200 bar, more preferably ≧30 bar≦80 bar.

In a further embodiment of the process according to the invention, the reaction is conducted at a temperature of ≧90° C. to ≦150° C., preferably ≧95° C. and ≦130° C., more preferably ≧100° C. and ≦120° C.

In a further embodiment of the process according to the invention, the ratio of gaseous olefin to CO during the reaction is variable over time. In this way, it is possible to obtain gradient polymers.

In a further embodiment of the process according to the invention, the catalyst or a mixture of the catalyst components is injected into the reactor containing olefin or a mixture of olefin and CO at a temperature of ≧90° C. to ≦150° C., preferably at the reaction temperature. The advantage of this embodiment is that the starting time of the polymerization reaction and the starting conditions, especially pressure and temperature, are clearly defined. This leads, more particularly, to a more homogeneous molecular weight distribution in the olefin-CO copolymer obtained. Moreover, any possible deactivation of the catalyst during the heating operation is avoided.

The present invention further relates to an olefin-CO copolymer obtainable by a process according to the invention, wherein the content of CO incorporated into the copolymer is ≦5 mol % based on all the monomers incorporated and the copolymer has an alternating fraction of ≦32.5 mol %. The determination of the contents of CO incorporated and of the alternating fraction is described in detail in the experimental section below. Preferably, the content of CO incorporated into the copolymer is ≧0.1 mol % to ≦5 mol %, more preferably ≧0.3 mol % to ≦4.7 mol %. It is additionally preferable that the copolymer has a content of alternating CO-olefin units of ≧1 mol % to ≦32.5 mol %, more preferably ≧10 mol % to ≦32 mol %.

In one embodiment of this olefin-CO copolymer, it has a number-average molecular weight Mₙ of ≦15 000 g/mol. This molecular weight can be determined most conveniently by means of NMR spectroscopy, as explained in the experimental section. The molecular weight Mₙ is preferably ≧900 g/mol to ≦15 000 g/mol, more preferably ≧950 g/mol to ≦13 000 g/mol.

In a further embodiment of this olefin-CO copolymer, it has a level of branching of ≦14.0, preferably ≦8, more preferably ≦5, branches per 1000 carbon atoms. The level of branching indicates the average number of branches per 1000 carbon atoms present in the polymer and can be determined, for example, by ¹³C NMR spectroscopy via the ratio of the area integrals of the signals for branching (i.e. at least trisubstituted) carbon atoms I_{C br.} to the sum total of the area integrals I, of all the signals for the carbon atoms i present in the polymer.

Since every branch introduces an additional end group into the polymer, the level of branching can likewise be determined via the average number of additional end groups, i.e. of the end groups present in branched chains in addition to the two present theoretically in a linear chain, per 1000 carbon atoms present in the polymer.

The level of branching VG is then according to formula (II)

$$V G = 1000 \times \frac{{n}_{EG , Mol} - 2}{{n}_{C , Mol}} \qquad ( II )$$

where n_{EG, Mol} is the average number of end groups per molecule and n_{C, Mol} is the average total number of carbon atoms per molecule. This determination can be effected, for example, by means of ¹H NMR spectroscopy and is described in detail in the description of the methods.

In a further embodiment of this olefin-CO copolymer, the semicrystallinity of this olefin-CO copolymer is <50%, preferably ≦30%, more preferably ≦21%. The semicrystallinity can be determined by means of differential scanning calorimetry (DSC). The determination of the semicrystallinity is described in detail in the description of the methods.

In a further embodiment of this olefin-CO copolymer, the melting point of this olefin-CO copolymer is <140° C., preferably ≦130° C., more preferably ≦126.7° C. The semicrystallinity can be determined by means of differential scanning calorimetry (DSC). The determination of the semicrystallinity is described in detail in the description of the methods.

The present invention further provides a polyol compound obtainable by reducing an inventive olefin-CO copolymer. Under reductive conditions, it is possible to obtain, from the olefin-CO copolymers, polyalcohols which likewise find various uses, for example as plasticizers or in the preparation of polyurethane polymers or formaldehyde resins.

The reduction can be conducted, for example, by hydrogenation with hydrogen over heterogeneous or homogeneous metal catalysts. It is alternatively possible to reduce with alkali metals or hydride reagents, for example sodium borohydride, lithium aluminium hydride, borane (for example as the tetrahydrofuran or dimethyl sulphide complex), alkyl- or dialkylboranes or silanes having the structure SiH₄₋ₐRₐ where a=1, 2 or 3 and R=alkyl or aryl radical.

The hydrogenation with hydrogen can be conducted, for example, by processes which are described in J. Polymer Science (1998), 889 and Recent Research Developments in Polymer Science (1999), 355, JP 01-149828, JP 11-035676, JP 11-035677, EP 0 791 615 A1, JP 02-232228, EP 830 932 A2, EP 0 735 081 A2, JP 10-081745 and JP 09-235370.

In a preferred process, the reduction of the olefin-CO copolymers to the corresponding polyalcohols is effected with molecular hydrogen using a heterogeneous hydrogenation catalyst. The hydrogenation is effected preferably at temperatures between 20° C. and 200° C. and at pressures between 10 bar and 100 bar. The content of heterogeneous hydrogenation catalyst may, for example, be 0.01% by weight to 100% by weight (metal content based on the polymer), preferably 0.1% by weight to 40% by weight.

Preferred catalysts contain the elements cobalt, nickel, ruthenium, rhodium and/or iridium. The catalysts can be used in the form of Raney catalysts or on suitable supports. Particular preference is given to using Raney nickel, Raney cobalt, or supported cobalt, nickel, ruthenium and rhodium catalysts. The catalysts may also be present as mixtures of the preferred elements cobalt, nickel, ruthenium, rhodium, iridium with one another, or contain ≦50% by weight, based on the metal content, of other elements, for example rhenium, palladium or platinum.

The heterogeneous hydrogenation catalyst may additionally be free of palladium and platinum, “free of” including impurities unavoidable in an industrial context.

Suitable support materials are particularly carbon and oxides, such as silicon dioxide, aluminium dioxide, mixed oxides composed of silicon dioxide and aluminium dioxide, and titanium dioxide.

The hydrogenation can be conducted in the presence or absence of solvents. Suitable solvents are particularly C₁- to C₈-alcohols and mixtures of these with one another or with other solvents such as THF or 1,4-dioxane.

In one variant, the hydrogenation is conducted at a hydrogen pressure of ≦100 bar. This should be understood to mean the hydrogen pressure which exists on commencement of the hydrogenation reaction if the reaction temperature envisaged has already been attained. For example, a hydrogen pressure of 80 bar can be thus set at room temperature, which rises to 100 bar after heating to a reaction temperature of approx. 200° C. This hydrogen pressure is preferably ≧40 bar to ≦100 bar. Particular preference is given to a hydrogen pressure of ≧80 bar to ≦100 bar.

In a further variant, the hydrogenation is effected in the presence of a solvent or solvent mixture comprising hydroxyl groups. The term “solvent comprising hydroxyl groups” includes water. One example of a particularly suitable solvent is 2-propanol (isopropanol). A further example is a mixture of 2-propanol with water in a volume ratio of ≧5:1 to ≦10:1. The component containing hydroxyl groups in the solvent mixture may also be provided by water alone. One example thereof is a mixture of 1,4-dioxane with water in a volume ratio of ≧5:1 to ≦10:1.

The polyalcohols obtained by reduction of an olefin-CO copolymer prepared by the process according to the invention are of particularly good suitability as plasticizers, crosslinkers or binders for coating materials chemically crosslinked with polyisocyanates or formaldehyde resins.

The present invention likewise relates to a polyamine and/or polyamine-polyalcohol compound obtainable by reductively aminating an inventive olefin-CO copolymer. Through reductive amination of the olefin-CO copolymers (prepared by the process according to the invention), it is possible to prepare polyamines or polyamine-polyalcohols containing both amino and hydroxyl groups.

The polyamines or polyamine-polyalcohols obtained by reductive amination of the olefin-CO copolymers are co-reactants of interest, for example for isocyanates or epoxides. Molecules containing more than two amine or hydroxyl groups are crosslinkers of interest, which, together with amine- or hydroxyl-reactive compounds, such as polyisocyanates or polyepoxides, can be combined to form three-dimensional networks. To control the reactivity, the primary amino groups can also be reacted with maleic esters to give aspartic esters, or with ketones or aldehydes to give ketimines or aldimines. In addition, the amine groups can be reacted with phosgene to give isocyanates. These polyisocyanates are likewise polymer units of interest.

The reductive amination can be effected by reaction of the olefin-CO copolymers (obtained by the process according to the invention) with hydroxylamine or hydroxylamine hydrochloride to give the corresponding polyoximes and subsequent reduction of the polyoximes obtained.

For the formation of the polyoximes from the olefin-CO copolymers (obtained by the process according to the invention), hydroxylamine is used in one- to ten-fold molar amounts based on the carbonyl groups present in the olefin-CO copolymers obtained by the process according to the invention. Preference is given to using hydroxylamine as an aqueous solution or in substance. However, it can also be released in situ from salts of hydroxylamine, such as hydrochloride or sulphate, with bases in aqueous or alcoholic solution. The reaction of the olefin-CO copolymers obtained by the process according to the invention with hydroxylamine can be conducted in a biphasic mixture. Preference is given to using a biphasic mixture which forms from the olefin-CO copolymer (obtained by the process according to the invention) or a solution of the olefin-CO copolymer (obtained by the process according to the invention) in an inert solvent such as benzene, toluene, chlorobenzene, dichlorobenzene, chloroform, dichloroethane or tetrachloroethane, and the aqueous hydroxylamine solution. In addition, it is also possible to use at least partly water-soluble solvents which are inert towards hydroxylamine, such as methanol, ethanol, isopropanol, n-propanol, n-butanol, dioxane, tetrahydrofuran (THF), N,N-dimethylformamide (DMF), N-methylpyrrolidone (NMP) or N,N-dimethylacetamide as solubilizers. The reaction is conducted at temperatures of 0 to 130° C. Subsequently, the polyoxime can be isolated by phase separation, filtration or/and distillative removal of the volatile constituents of the reaction mixture.

The polyoximes which have been prepared from the olefin-CO copolymers (obtained by the process according to the invention) are reduced with a suitable reducing agent, preferably molecular hydrogen with use of a selective homogeneous or heterogeneous hydrogenation catalyst. The hydrogenation with hydrogen is effected at temperatures of 20 to 200° C., preferably of 80 to 180° C., more preferably of 120 to 160° C., at pressures of 10 to 200 bar, preferably 10 to 100 bar, more preferably 10 to 50 bar, in the presence of 0.1 to 20% by weight of hydrogenation catalysts, such as for example cobalt, nickel, ruthenium, rhodium, palladium, iridium, platinum. The catalysts can be used in the form of Raney catalysts or on suitable supports. Preference is given to using Raney cobalt, Raney nickel, or supported cobalt, nickel or ruthenium catalysts. Suitable support materials are particularly carbon and oxides, such as silicon dioxide, aluminium dioxide, mixed oxides composed of silicon dioxide and aluminium dioxide, and titanium oxide. Preferably, the hydrogenation is conducted in the presence of ammonia, more preferably in an equimolar amount based on oxime groups. The hydrogenation can be conducted in the presence or absence of solvents. Examples of suitable solvents are THF, dioxane, or C1-C4-alcohols. Other reducing agents are alkali metals or the hydrides, alanates or boranates thereof.

In an alternative process, the reductive amination of the olefin-CO copolymers (obtained by the process according to the invention) can be obtained directly by the reaction thereof with ammonia and subsequent reduction, in which case the two process steps of reaction with ammonia and reduction can be performed simultaneously in a common reactor.

In one variant of the process for direct reductive amination of the olefin-CO copolymers (obtained by the process according to the invention), the reactor is a trickle bed reactor. By means of such a reactor, it is advantageously possible to achieve a high reaction temperature and a high catalyst/substrate ratio. Preferably, the reaction mixture comprising gas phase and liquid phase is passed in cocurrent downwards through the catalyst bed. However, gas phase and liquid phase can also be passed through the catalyst bed upwards in cocurrent or in countercurrent. In an alternative variant, the flow is from below towards a moving catalyst bed. Gas phase and liquid phase can be contacted with one another upstream of the reactor or within the reactor or in the catalyst bed.

The gas phase comprises hydrogen and gaseous ammonia, and optionally inert gas and/or solvent vapours. The liquid phase consists of the olefin-CO copolymer obtained by the process according to the invention, ammonia in liquid or dissolved form, and optionally solvents.

In a further variant, the heterogeneous hydrogenation catalyst comprises metals selected from the group comprising cobalt, nickel, ruthenium, rhodium, palladium, iridium and/or platinum. The catalysts can be used in the form of Raney catalysts or on suitable supports. It is also possible to use alloys containing the aforementioned metals. Alternatively, it is also possible to use mixtures of the aforementioned catalysts. Preference is given to using Raney cobalt, Raney nickel, or supported cobalt, nickel or ruthenium catalysts. Suitable support materials are particularly carbon and oxides, such as silicon dioxide, aluminium dioxide, mixed oxides composed of silicon dioxide and aluminium dioxide, and titanium oxide.

In a further variant of the process, the reaction is conducted at a temperature of ≧80° C. to ≦280° C. Preference is given to a temperature range of ≧160° C. to ≦240° C. Particular preference is given to a temperature range of ≧180° C. to ≦220° C.

In a further variant of the process, the reaction is conducted at a hydrogen pressure of ≧10 bar to ≦150 bar, preferably of ≧20 bar to ≦80 bar. Particular preference is given to a pressure range from ≧30 bar to ≦50 bar.

In a further variant of the process, the reaction is conducted with a residence time of the liquid phase in the catalyst bed of the fixed bed reactor of ≧1 second to ≦1 hour. Preferred residence times are in the range from ≧5 seconds to ≦10 minutes. Particularly preferred residence times are in the range from ≧10 seconds to ≦5 minutes.

In a further variant of the process, the molar ratio of ammonia to keto groups in the olefin-CO copolymer used is ≧1:1 to ≦500:1. Preferred ratios are in the range from ≧3:1 to ≦100:1. Particularly preferred ratios are in the range from ≧5:1 to ≦50:1.

The olefin-CO copolymer (obtained by the process according to the invention) can be used in liquid or molten form in pure substance, or dissolved in a solvent. In a further embodiment, the reductive amination is conducted in the presence of a solvent selected from the group comprising C₁-C₄-alcohols, 1,2-dioxane, 1,3-dioxane, 1,4-dioxane, tetrahydrofuran, 2-methyltetrahydrofuran, 3-methyltetrahydrofuran, 2,5-dimethyltetrahydrofuran, tetrahydrofurfuryl methyl ether, tetrahydrofurfuryl ethyl ether, 2,5-dimethoxymethyltetrahydrofuran, 2,5-diethoxymethyltetrahydrofuran, furfuryl acetate, tetrahydrofuran-2-carboxylic acid methyl ester, 1,3-dioxolane, tetrahydropyran and/or haloalkanes (such as dichloromethane, 1,2-dichloroethane, 1,1,2,2-tetrachloroethane or higher homologues thereof).

In a further variant, the reductive amination is performed in the presence of liquid ammonia as a solvent or with ammonia dissolved in a solvent.

In a preferred embodiment of the process, the olefin-CO copolymer first comes into contact with the ammonia within the catalyst bed of the fixed bed reactor. In this way, formation of sparingly soluble crosslinked imines which can precipitate out is prevented.

The polyamines or polyamine-polyalcohols obtained are of particularly good suitability as co-reactants for isocyanates and epoxides, as reactants for the phosgenation to give polyisocyanates, and for the production of elastic coatings or mouldings. The conversion products with dialkyl maleates (polyaspartates) and with ketones or aldehydes (polyketimines or polyaldimines) are of particularly good suitability as co-reactants for polyisocyanates.

Finally, the use of inventive olefin-CO copolymers, of inventive polyol compounds and/or of inventive polyamine and/or polyamine-polyalcohol compounds as polymer additives and/or for preparation of polyurethane and/or polyurea polymers also forms part of the present invention. More particularly, the inventive olefin-CO copolymers, the inventive polyol compounds and the inventive polyamine or polyamine-polyalcohol compounds find use, for example, as plasticizers for PVC, as binders, as polymer additives or crosslinkers, or in powder coating materials. Therefore, the present invention further relates to the use of the olefin-CO copolymers obtained by the process according to the invention, of the inventive polyalcohols and/or of the inventive polyamines- and/or polyamine-polyalcohols as plasticizers for PVC, as binders, as polymer additives or crosslinkers, or in powder coating materials.

The present invention is illustrated in detail by the examples which follow, but without being restricted thereto.

### Examples

### Description of the Methods

The polymerization reactions were conducted in a 300 ml stainless steel autoclave with a glass insert. The system was equipped with a mechanical stirrer and automatic internal cooling. The heating was effected by means of a heating jacket and was controlled via the internal reactor temperature. The catalyst solution was prepared in a Schlenk tube under argon and transferred with a syringe in an argon countercurrent into a gas burette which was connected to the reactor interior via an immersed tube equipped with an isolating valve. The gas mixture of gaseous olefin and CO (composition stated in % by volume) was initially charged in a mixing chamber having a volume of 3.8 l at a pressure of 60 bar. The gas was supplied to the reactor, as appropriate, via a Bronckhorst mass flow controller (MFC) (capacity 2 standard litres/min) coupled to a pressure sensor connected to the reactor interior, a bypass line or the gas burette. The reactor was charged with the gaseous olefin or the gas mixture of gaseous olefin and CO at the start of the reaction via the bypass line. The catalyst solution was injected by charging the gas burette with the gaseous olefin or the gas mixture of gaseous olefin and CO, and opening the connection to the reactor. The fine adjustment of the total pressure after injection of the catalyst was made using the MFC. The metered addition of the gaseous olefin or of the gas mixture of gaseous olefin and CO over the course of the reaction was effected via the MFC by compensation for the pressure drop which occurred during the reaction. To end the reaction, the gas supply was closed and the autoclave was cooled to room temperature with the aid of the internal cooling and optionally by means of external cooling with the aid of an ice bath or water bath.

The following reagents and gases were used without further purification:

ethylene (3.0), Gerling Holz & Co., Hamburg

carbon monoxide CO (3.7), Praxair, Belgium

1-hexene, CAS [592-41-6], Catalogue No. 320323, Aldrich (was distilled before use)

styrene, CAS [100-42-5], Catalogue No. W323306, Aldrich

palladium acetate (Pd(OAc)₂, CAS [3375-31-3]), Catalogue No. 379875, Aldrich

ligand P̂O (2-[bis(2-methoxyphenyl)phosphino]benzenesulphonic acid), CAS [257290-43-0], Convertex

The complex catalyst [Pd(dcpOEt)(P̂O)](=[(1-η²,5-η¹-6-ethoxy-exo-5,6-dihydrodicyclopentadiene){2-[bis(2-methoxyphenyl)phosphino]benzenesulphonato}palladium]) was synthesized according to Organometallics (2005) 2754, compound 2b.

The solvent used was dichloromethane, which was dried over CaCl₂, 4 Å molecular sieve and F 200 and then degassed with argon.

Analysis:

¹H NMR spectroscopy: The measurements were effected on a Bruker AV300 (300 MHz) at 95° C.; the calibration of the chemical shifts was effected relative to the solvent signal (chlorodeuterobenzene C₆D₅Cl, shift of the low-field signal: 8=7.14 ppm; 1,2-dichlorodeuterobenzene C₆D₄Cl₂, shift of the low-field signal: 8=7.19 ppm); s=singlet, m=multiplet, bs=broadened singlet, kb=complex region. The integrals are reported relative to one another. The signals were assigned as follows (relevant group underlined):

Ethylene-CO Copolymers:

| δ [ppm] | | |
|---|---|---|
| (rough FIGURE) | Integral | Chem. group |
| 0.7-0.95 | A | —CH₃ |
| 1.0-1.5 | B | —CH₂—CH₂—CH₂— |
| 1.5-1.7 | C | —CO—CH₂—CH₂—CH₂— |
| 1.9-2.1 | D | —CH₂—CH₂—CH═CH₂— |
| 2.1-2.3 | E | —CO—CH₂—CH₂—CH₂— |
| 2.4-2.6 | F | —CO—CH₂—CH₂—CO— |
| 4.9-5.1 | G | —CH═CH₂ |
| 5.3-5.4 | H | —CH═CH— |
| 5.7-5.9 | I | —CH═CH₂ |

The molar CO content x_{CO} (in mol %) is calculated from the area integrals A to I as follows:

$${x}_{CO} = 100 \% \times \frac{E + F}{A + B + C + D + 2 E + 2 F + G + H + I}$$

The molar ethylene content x_{ethylene} (in mol %) is calculated by:

x_{ethylene}=100%−x_{CO}

For ethylene-CO copolymers, the molar proportions xᵢ of the monomers i (ethylene or CO) can be equated to the relative proportions by weight yᵢ (in % by weight) of the monomers i.

The proportion xₐₗₜ of alternating units (in mol %) is calculated from the integrals E and F by:

$${x}_{alt} = 100 \% \times \frac{F}{E + F}$$

The average molecular weight MW is calculated under the assumption that one double bond is present per polymer chain, by:

$$MW = \frac{14 \times \frac{A + B + C + D + E + F + G + H + I}{2} + 28 \times \frac{E + F}{4}}{\frac{G + H}{2}}$$

The level of branching VG is calculated by formula (II), where

$${n}_{EG , Mol} = \frac{\frac{A}{3} + \frac{G}{2}}{\frac{G + H}{2}} and$$

$${n}_{C , Mol} = \frac{\frac{A + B + C + D + E + F + G + H + I}{2} + \frac{E + F}{4}}{\frac{G + H}{2}}$$

Ethylene-CO-1-Hexene Terpolymers:

| δ [ppm] | | |
|---|---|---|
| (rough | | |
| FIGURE) | Integral | Chem. group |
| 0.7-1.0 | A′ | —CH₃ |
| 1.0-1.5 | B′ | —CH₂—CH₂—CH₂— |
| 1.5-1.7 | C′ | —CO—CH₂—CH₂—CH₂/—CH₂CH(ⁿBu)CH₂— |
| 1.9-2.1 | D′ | —CH₂—CH₂—CH═CH₂/ |
| | | —CH₂—CH₂—CH═CH— |
| 2.1-2.3 | E′ | —CO—CH₂—CH₂—CH₂— |
| 2.4-2.6 | F′ | —CO—CH₂—CH₂—CO— |
| 4.75 | G′ | —CH₂—C(ⁿBu)═CHH′ |
| 4.9-5.1 | H′ | —CH═CH₂/—C(ⁿBu)═CHH′ |
| 5.3-5.5 | I′ | —CH═CH— |
| 5.7-5.9 | J′ | —CH═CH₂ |

The proportions by weight yᵢ of the individual monomers i (ethylene, CO and 1-hexene) are calculated from the integrals A′ to J′ as follows:

$${y}_{1 - hexene} = 100 \% \times \frac{84 \times ( \frac{{A}^{′}}{3} - \frac{{G}^{′} + {H}^{′}}{2} )}{14 \times \frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′}\end{matrix}}{2} + 28 \times \frac{{E}^{′} + {F}^{′}}{4}}$$

$${y}_{CO} = 100 \% \times \frac{28 \times \frac{{E}^{′} + {F}^{′}}{4}}{14 \times \frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′}\end{matrix}}{2} + 28 \times \frac{{E}^{′} + {F}^{′}}{4}}$$

$${y}_{ethylene} = 100 \% - {y}_{1 - hexene} - {y}_{CO}$$

The molar proportions xᵢ of the individual monomers i (ethylene, CO and 1-hexene) are calculated from the proportions by weight yᵢ, where M_{ethylene}=28 g/mol, M_{CO}=28 g/mol and M₁₋ₕₑₓₑₙₑ=84 g/mol, as follows:

$${x}_{i} = \frac{{y}_{i} / {M}_{i}}{{\sum }_{i} {y}_{i} / {M}_{i}}$$

The proportion xₐₗₜ of alternating units (in mol %) is calculated from the integrals E′ and F′ by:

$${x}_{alt} = 100 \% \times \frac{{F}^{′}}{{E}^{′} + {F}^{′}}$$

The average molecular weight MW is calculated under the assumption that one double bond is present per polymer chain, by:

$$MW = \frac{14 \times \frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′}\end{matrix}}{2} + 28 \times \frac{{E}^{′} + {F}^{′}}{4}}{\frac{{G}^{′} + {H}^{′}}{2} + \frac{{I}^{′}}{2}}$$

The level of branching VG is calculated by formula (II), where

$${n}_{EG , Mol} = \frac{\frac{{A}^{′}}{3} + \frac{{G}^{′} + {H}^{′}}{2}}{\frac{{G}^{′} + {H}^{′}}{2} + \frac{{I}^{′}}{2}} and$$

$${n}_{C , Mol} = \frac{\frac{\begin{matrix}{A}^{′} + {B}^{′} + {C}^{′} + {D}^{′} + {E}^{′} + \\ {F}^{′} + {G}^{′} + {H}^{′} + {I}^{′} + {J}^{′}\end{matrix}}{2} + \frac{{E}^{′} + {F}^{′}}{4}}{\frac{{G}^{′} + {H}^{′}}{2} + \frac{{I}^{′}}{2}}$$

Ethylene-CO-Styrene Terpolymers:

The chemical shift was calibrated using the maximum of the methylene signal having the integral B″(—CH₂—CH₂—CH₂—), δ=1.37 ppm.

| δ [ppm] | | |
|---|---|---|
| (rough FIGURE) | Integral | Chem. group |
| 0.7-1.0 | A″ | —CH₃ |
| 1.0-1.5 | B″ | —CH₂—CH₂—CH₂— |
| 1.5-1.7 | C″ | —CO—CH₂—CH₂—CH₂— |
| 1.9-2.1 | D″ | —CH₂—CH₂—CH═CH₂/ |
| | | —CH₂—CH₂—CH═CH— |
| 2.1-2.3 | E″ | —CO—CH₂—CH₂—CH₂— |
| 2.4-2.6 | F″ | —CO—CH₂—CH₂—CO— |
| 2.6-2.8 | S₁ | —CH₂—CHPh—CH₂— |
| 4.9-5.1 | H″ | —CH═CH₂ |
| 5.3-5.5 | I″ | —CH═CH— |
| 5.7-5.9 | J″ | —CH═CH₂ |
| 6.0-6.3 | S₂ | —CH═CH—Ph |
| 6.4-6.5 | S₃ | —CH═CH—Ph |
| 6.5-6.8 | | CHₐᵣ |
| 6.9-7.6 | | CHₐᵣ |

The signals of the CH_{af} groups overlap with the signals of the solvent (C₆D₅Cl); therefore, the integrals of these signals cannot be used to determine the styrene content. The styrene content was therefore determined via the integrals S₁, S₂ and S₃.

The proportions by weight yᵢ of the individual monomers i (ethylene, CO and styrene) are calculated from the integrals A″ to J″ and S₁ to S₃ as follows:

$${y}_{styrene} = 100 \% \times \frac{104 \times ( {S}_{1} + {S}_{3} )}{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″} + {S}_{2} ) + 90 \times ( {S}_{1} + {S}_{3} ) + 28 \times \frac{{E}^{″} + {F}^{″}}{4}\end{matrix}}$$

$${y}_{CO} = 100 \% \times \frac{28 \times \frac{{E}^{′} + {F}^{′}}{4}}{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″} + {S}_{2} ) + 90 \times ( {S}_{1} + {S}_{3} ) + 28 \times \frac{{E}^{″} + {F}^{″}}{4}\end{matrix}}$$

$${y}_{ethylene} = 100 \% \times \frac{14 \times \frac{{A}^{″} + {B}^{″} + {C}^{″} + {D}^{″} + {E}^{″} + {F}^{″} + {H}^{″} + {I}^{″} + {J}^{″} - 2 \times {S}_{1}}{2}}{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″} + {S}_{2} ) + 90 \times ( {S}_{1} + {S}_{3} ) + 28 \times \frac{{E}^{″} + {F}^{″}}{4}\end{matrix}}$$

The molar proportions xᵢ of the individual monomers i (ethylene, CO and styrene) are calculated from the proportions by weight yᵢ, where M_{ethylene}=28 g/mol, M_{CO}=28 g/mol and M_{styrene}=104 g/mol, as follows:

$${x}_{i} = \frac{{y}_{i} / {M}_{i}}{{\sum }_{i} {y}_{i} / {M}_{i}}$$

The proportion xₐₗₜ of alternating units (in mol %) is calculated from the integrals E″ and F″ by:

$${x}_{alt} = 100 \% \times \frac{{F}^{″}}{{E}^{″} + {F}^{″}}$$

The average molecular weight MW is calculated under the assumption that one double bond is present per polymer chain, by:

$$MW = \frac{\begin{matrix}15 \times \frac{{A}^{″}}{3} + 14 \times \frac{{B}^{″} + {C}^{″} + {D}^{″} + {E}^{″} + {F}^{″} + {H}^{″}}{2} + \\ 13 \times ( {I}^{″} + {J}^{″ } + {S}_{2} ) + 90 \times ( {S}_{1} + {S}_{3} ) + 28 \times \frac{{E}^{″} + {F}^{″}}{4}\end{matrix}}{\frac{{H}^{″} + {I}^{″}}{2} + {S}_{3}}$$

The level of branching VG is calculated by formula (II), where

$${n}_{EG , Mol} = \frac{\frac{{A}^{″}}{3} + {S}_{1} + \frac{{H}^{″}}{2} + {S}_{3}}{\frac{{H}^{″}}{2} + \frac{{I}^{″}}{2} + {S}_{3}} and$$

$${n}_{C , Mol} = \frac{\frac{{A}^{″}}{3} + \frac{{B}^{″} + {C}^{″} + {D}^{″} + {E}^{″} + {F}^{″} + {H}^{″}}{2} + {S}_{1} + {I}^{″} + {J}^{″} + {S}_{2} + {S}_{3}}{\frac{{H}^{″}}{2} + \frac{{I}^{″}}{2} + {S}_{3}}$$

Infrared (IR) spectroscopy: The measurements were effected on a Bruker Alpha-P FT-IR spectrometer; the measurements were effected in pure substance; the wavenumber of the maximum of the signal for the CO stretching vibration ν(CO) is reported.

The viscosity was determined on a Physica MCR 501 rheometer from Anton Paar. A cone-plate configuration having a separation of 50 μm was selected (DCP25 measurement system). 0.1 g of the substance was applied to the rheometer plate and subjected to a shear of 0.01 to 1000 l/s at 160° C., and the viscosity was measured every 10 s for 10 min. The viscosity averaged over all the measurement points is reported.

The melting points were determined by DSC (differential scanning calorimetry) on a DSC 1 STAR^{e} from Mettler Toledo. The sample was analysed at a heating rate of 10 K/min over two heating cycles from −80° C. to +250° C. The melting point reported was the heat absorption maximum of the second heating rate.

The semicrystallinity was determined by DSC (differential scanning calorimetry) on a DSC 1 STAR^{e} from Mettler Toledo. A sample of the polymer was placed onto the sample holder. This was then equilibrated to 25° C. in an argon stream. Then the sample was heated at a heating rate of 10 K/min to a temperature of at least 50° C. below the decomposition temperature (typically to 200° C.), then cooled at a rate of 10 K/min to 25° C. and held at this temperature for 2 min. Subsequently, this heating cycle was repeated.

The semicrystallinity of the polymer sample was calculated by the formulae (IV) to (VI), where H′ represents the heat that was released by the fraction of the polymer which was in crystalline form prior to the heating, Hₘ the enthalpy of fusion, H_{c} the heat absorbed in the course of cooling, H*ₘ the specific enthalpy of fusion, m_{c} the mass of the crystalline polymer component, m the mass of the overall sample, and χ the semicrystallinity in per cent.

$$\begin{matrix}{H}^{′} = {H}_{m} - {H}_{c} & ( IV ) \\ {m}_{c} = \frac{{H}^{′}}{{H}_{m}^{*}} & ( V ) \\ χ = \frac{{m}_{c}}{m} \times 100 \% & ( VI )\end{matrix}$$

Gel permeation chromatography (GPC): The molecular weight was determined by high-temperature GPC at Polymer Standards Services (PSS), Mainz. The analysis was conducted at 150° C. in 1,2,4-trichlorobenzene as the eluent at a flow rate of 1.0 ml/min. Column: PSS Polyolefin 10 μm, LinXL, ID 8.0 mm×300 mm The calibration standards used were polystyrene samples of known molecular weight.

The purpose of the examples which follow is to elucidate the invention in more detail.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### Examples

### Example 1

### Copolymerization of Ethylene and CO with a Catalyst Generated In Situ at an Ethylene/CO Ratio of 98:2

A 300 ml stainless steel pressure reactor with a glass insert was initially charged with 95 ml of dichloromethane and the reactor was flooded with argon. Subsequently, the reactor was charged at room temperature with a mixture of 98% ethylene and 2% CO to a total pressure of 13 bar. The mixture was then heated to 110° C. while stirring at 500 rpm, in the course of which the total pressure in the reactor rose to 19 bar. On attainment of the reaction temperature, 11.2 mg (0.05 mmol) of Pd(OAc)₂ and 30.2 mg (0.075 mmol) of ligand P̂O were dissolved in 5 ml of dichloromethane and injected into the reaction mixture via a pressure burette with the aid of a gas mixture of 98% ethylene and 2% CO, in the course of which the total pressure rose to 44 bar. Subsequently, the total pressure was adjusted to 50 bar with a gas mixture of 98% ethylene and 2% CO, and the reaction mixture was stirred at 110° C. at constant pressure, which was regulated by supplying further gas mixture, for 15.5 hours. After the reaction time was complete, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

33 g of a copolymer of ethylene and CO were obtained. Thus, a TON of 660 g/mmol_{Pd} and a TOF of 36.7 g/(mmol_{Pd}×h) were achieved.

Melting point: 125.8° C.

Viscosity (160.9° C.): 0.804 Pa·s

IR: ν(CO)=1718 cm⁻¹

¹H NMR (300 MHz, C₆D₅Cl, 95° C.): δ=0.74-0.96 (8.327H), 0.96-1.18 (7.498H), 1.18-1.43 (640.12H), 1.43-1.64 (13.85H), 1.91-2.07 (2.906H), 2.12-2.33 (8.461H), 2.39-2.59 (1.966H), 4.85-5.04 (2.155H), 5.34-5.45 (0.196H), 5.67-5.86 (0.999H) ppm.

The molar proportions of the monomers in the product were 98.5 mol % of ethylene and 1.5 mol % of CO.

The alternating fraction was 18.9 mol %.

From the proportion of double bonds in the ¹H NMR spectrum, an average molecular weight of Mₙ=4150 g/mol is calculated.

The level of branching was VG=4.21 branches per 1000 carbon atoms.

The semicrystallinity was χ=20.1%.

### Comparative Example 1

Copolymerization of ethylene and CO with a catalyst generated in situ at an ethylene/CO ratio of 98:2 in a batchwise process

A 300 ml stainless steel pressure reactor with a glass insert was initially charged with 95 ml of dichloromethane and the reactor was flooded with argon. Subsequently, the reactor was charged at room temperature with a mixture of 98% ethylene and 2% CO to a total pressure of 13 bar. The mixture was then heated to 110° C. while stirring at 500 rpm, in the course of which the total pressure in the reactor rose to 19 bar. On attainment of the reaction temperature, 11.2 mg (0.05 mmol) of Pd(OAc)₂ and 30.2 mg (0.075 mmol) of ligand P̂O were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, the gas supply was closed and the reaction mixture was stirred at 110° C. for 18 h. After the reaction time was complete, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

14.1 g of a copolymer of ethylene and CO were obtained. Thus, a TON of 282 g/mmol_{Pd} and a TOF of 15.7 g/(mmol_{Pd}×h) were attained.

Melting point: 123.9° C.

Viscosity (160° C.): 1.278 Pa·s

IR: ν(CO)=1711 cm⁻¹

¹H NMR (300 MHz, C₆D₅Cl, 95° C.): δ=0.71-0.94 (5.641H), 0.94-1.41 (507.53H), 1.41-1.66 (12.62H), 1.87-2.10 (2.891H), 2.10-2.42 (7.606H), 2.42-2.68 (3.75H), 4.77-5.02 (2.111H), 5.28-5.44 (0.291H), 5.63-5.85 (1.000H) ppm.

The molar proportions of the monomers in the product were 97.95 mol % of ethylene and 2.05 mol % of CO.

The alternating fraction was 33.0 mol %.

From the proportion of double bonds in the ¹H NMR spectrum, an average molecular weight of Mₙ=3234 g/mol is calculated.

The level of branching was VG=1.92 branches per 1000 carbon atoms.

Comparison:

It is clearly apparent from the comparative example that, when the reaction is conducted in a batchwise process, i.e. without supply of further ethylene and CO in the course of reaction, under otherwise identical reaction conditions, an ethylene-CO polymer having a much higher alternating fraction is formed. Compared to Example 1 (TOF=36.7 g/(mmol_{Pd}×h)), a much lower TOF (15.7 g/(mmol_{Pd}×h)) was achieved in this comparative example.

### Example 2

### Copolymerization of Ethylene and CO with a Catalyst Generated In Situ at an Ethylene/CO Ratio of 90:10

A 300 ml stainless steel pressure reactor with a glass insert was initially charged with 100 ml of dichloromethane and the reactor was flooded with argon. Subsequently, the reactor was charged at room temperature with a mixture of 90% ethylene and 10% CO to a total pressure of 15 bar. The mixture was then heated to 110° C. while stirring at 500 rpm, in the course of which the total pressure in the reactor rose to 21.6 bar. On attainment of the reaction temperature, the pressure was adjusted to 28.8 bar with a mixture of 90% ethylene and 10% CO. Subsequently, 11.3 mg (0.05 mmol) of Pd(OAc)₂ and 30.3 mg (0.075 mmol) of ligand P̂O were dissolved in 5 ml of dichloromethane and injected into the reaction mixture via a pressure burette with the aid of a gas mixture of 90% ethylene and 10% CO, the total pressure was adjusted to 50 bar with a gas mixture of 90% ethylene and 10% CO, and the reaction mixture was stirred at 110° C. at constant pressure, which was regulated by supply of further gas mixture, for 17.3 hours. After the reaction time was complete, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

9.2 g of a copolymer of ethylene and CO were obtained. Thus, a TON of 184 g/mmol_{Pd} and a TOF of 10.6 g/(mmol_{Pd}×h) were attained.

Melting point: 126.7° C.

Viscosity (160.2° C.): 0.74 Pa·s

IR: ν(CO)=1711 cm⁻¹

¹H NMR (400 MHz, C₆D₅Cl, 95° C.): δ=0.61-1.04 (10.87H), 1.04-1.18 (4.979H), 1.18-1.43 (395.69H), 1.43-1.73 (17.50H), 1.89-2.10 (3.237H), 2.10-2.36 (13.47H), 2.37-2.68 (3.965H), 4.85-5.03 (2.061H), 5.29-5.48 (0.811H), 5.66-5.85 (1.000H) ppm.

The molar proportions of the monomers in the product were 96.3 mol % of ethylene and 3.7 mol % of CO.

The alternating fraction was 22.7 mol %.

From the proportion of double bonds in the ¹H NMR spectrum, an average molecular weight of Mₙ=2296 g/mol is calculated.

The level of branching was VG=7.57 branches per 1000 carbon atoms.

The semicrystallinity was χ=7.4%.

### Comparative Example 2

### Copolymerization of Ethylene and CO with a Catalyst Generated In Situ at a Lowered Ethylene/CO ratio of 80:20

A 300 ml stainless steel pressure reactor with a glass insert was initially charged with 100 ml of dichloromethane and the reactor was flooded with argon. Subsequently, the reactor was charged at room temperature with a mixture of 80% ethylene and 20% CO to a total pressure of 14.9 bar. The mixture was then heated to 110° C. while stirring at 500 rpm. On attainment of the reaction temperature, the pressure was adjusted to 27.7 bar with a mixture of 80% ethylene and 20% CO. Subsequently, 11.1 mg (0.05 mmol) of Pd(OAc)₂ and 31.1 mg (0.077 mmol) of ligand P̂O were dissolved in 5 ml of dichloromethane and injected into the reaction mixture via a pressure burette with the aid of a gas mixture of 80% ethylene and 20% CO, the total pressure was adjusted to 50 bar with a gas mixture of 80% ethylene and 20% CO, and the reaction mixture was stirred at 110° C. at constant pressure, which was regulated by supply of further gas mixture, for 18 hours. After the reaction time was complete, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

11.8 g of a copolymer of ethylene and CO were obtained. Thus, a TON of 236 g/mmol_{Pd} and a TOF of 13.1 g/(mmol_{Pd}×h) were attained.

The product was in unmolten form below 180° C.

IR: ν(CO)=1707 cm⁻¹

¹H NMR (300 MHz, C₆D₄Cl₂, 95° C.): δ=0.61-0.87 (7.165H), 0.87-1.00 (5.734H), 1.00-1.31 (266.34H), 1.31-1.61 (66.55H), 1.96-2.29 (62.03H), 2.29-2.55 (19.28H), 4.74-4.98 (1.608H), 5.59-5.80 (1.000H) ppm.

The molar proportions of the monomers in the product were 84.1 mol % of ethylene and 15.9 mol % of CO.

The alternating fraction was 23.7 mol %.

From the proportion of double bonds in the ¹H NMR spectrum, an average molecular weight of Mₙ=4449 g/mol is calculated.

The level of branching was VG=6.20 branches per 1000 carbon atoms.

The semicrystallinity was χ=8.5%.

Comparison:

The comparative example shows that, at an ethylene/CO ratio of 80:20, compared to Example 1 (ethylene:CO=98:2) and Example 2 (ethylene:CO=90:10), an ethylene-CO copolymer with a significantly higher CO content (15.9 mol % compared to 1.5 mol % in Example 1 and 3.7 mol % in Example 2) was obtained. In addition, the comparative example shows that, at an ethylene/CO ratio≧80:20, ethylene-CO copolymers having a melting point above 140° C. are obtained.

### Example 3

### Copolymerization of Ethylene and CO with a Catalyst Generated In Situ at an Ethylene/CO Ratio of 98:2 and with Shortened Reaction Time

A 300 ml stainless steel pressure reactor with a glass insert was initially charged with 95 ml of dichloromethane and the reactor was flooded with argon. Subsequently, the reactor was charged at room temperature with a mixture of 98% ethylene and 2% CO to a total pressure of 13 bar. The mixture was then heated to 110° C. while stirring at 500 rpm. On attainment of a temperature of 100° C., the pressure was adjusted to 33 bar with a mixture of 98% ethylene and 2% CO, On attainment of a temperature of 110° C., 11.2 mg (0.05 mmol) of Pd(OAc)₂ and 30.4 mg (0.076 mmol) of ligand P̂O were dissolved in 5 ml of dichloromethane and injected into the reaction mixture via a pressure burette with the aid of a gas mixture of 98% ethylene and 2% CO. The total pressure was adjusted to 51 bar with a gas mixture of 98% ethylene and 2% CO, and the reaction mixture was stirred at 110° C. at constant pressure, which was regulated by supplying further gas mixture, for 2.6 hours. After the reaction time was complete, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

5.57 g of a copolymer of ethylene and CO were obtained. Thus, a TON of 111 g/mmol_{Pd} and a TOF of 42.8 g/(mmol_{Pd}×h) were achieved.

Melting point: 120.5° C.

Viscosity (160.1° C.): 1.134 Pa·s

IR: ν(CO)=1715 cm⁻¹

¹H NMR (300 MHz, C₆D₅Cl, 95° C.): δ=0.79-0.95 (10.51H), 1.04-1.15 (7.653H), 1.17-1.47 (1024.52H), 1.48-1.68 (29.83H), 1.89-2.08 (4.635H), 2.15-2.30 (20.20H), 2.40-2.64 (7.380H), 4.87-5.03 (2.449H), 5.35-5.43 (0.742H), 5.70-5.87 (1.001H) ppm.

The molar proportions of the monomers in the product were 97.6 mol % of ethylene and 2.4 mol % of CO.

The alternating fraction was 26.8 mol %.

From the proportion of double bonds in the ¹H NMR spectrum, an average molecular weight of Mₙ=4986 g/mol is calculated.

The level of branching was VG=2.70 branches per 1000 carbon atoms.

The semicrystallinity was χ=17.1%.

### Example 4

### Copolymerization of Ethylene and CO with a Catalyst Generated In Situ at an Ethylene/CO Ratio of 98:2 and with Lower Catalyst Concentration

A 300 ml stainless steel pressure reactor with a glass insert was initially charged with 95 ml of dichloromethane and the reactor was flooded with argon. Subsequently, the reactor was charged at room temperature with a mixture of 98% ethylene and 2% CO to a total pressure of 15 bar. The mixture was then heated to 110° C. while stirring at 500 rpm, in the course of which a total pressure of 20 bar was attained. On attainment of the reaction temperature, the pressure was adjusted to 36 bar with a mixture of 98% ethylene and 2% CO. Then 8.3 mg (0.037 mmol) of Pd(OAc)₂ and 22.4 mg (0.056 mmol) of ligand P̂O were dissolved in 5 ml of dichloromethane and injected into the reaction mixture via a pressure burette with the aid of a gas mixture of 98% ethylene and 2% CO. The total pressure was adjusted to 50 bar with a gas mixture of 98% ethylene and 2% CO, and the reaction mixture was stirred at 110° C. at constant pressure, which was regulated by supplying further gas mixture, for 2 hours. After the reaction time was complete, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

5.6 g of a copolymer of ethylene and CO were obtained. Thus, a TON of 151 g/mmol_{Pd} and a TOF of 75.7 g/(mmol_{Pd}×h) were achieved.

Melting point: 121.8° C.

Viscosity (160.5° C.): 0.9428 Pa·s

IR: ν(CO)=1712 cm⁻¹

¹H NMR (300 MHz, C₆D₅Cl, 95° C.): δ=0.81-1.00 (12.87H), 1.00-1.18 (8.628H), 1.2-1.51 (1076.51H), 1.55-1.65 (35.46H), 1.96-2.02 (4.396H), 2.18-2.275 (22.14H), 2.493 (6.538H) 4.88-4.99 (2.452H), 5.395 (0.863H), 5.72-5.81 (1.001H) ppm.

The molar proportions of the monomers in the product were 97.6 mol % of ethylene and 2.4 mol % of CO.

The alternating fraction was 22.8 mol %.

From the proportion of double bonds in the NMR spectrum, an average molecular weight of Mₙ=5066 g/mol is calculated.

The level of branching was VG=3.67 branches per 1000 carbon atoms.

The semicrystallinity was χ=46.9%.

### Example 5

### Copolymerization of Ethylene and CO with a Catalyst Generated In Situ at an Ethylene/CO Ratio of 98:2 and a Reaction Temperature of 130° C.

A 300 ml stainless steel pressure reactor with a glass insert was initially charged with 95 ml of dichloromethane and the reactor was flooded with argon. Subsequently, the reactor was charged at room temperature with a mixture of 98% ethylene and 2% CO to a total pressure of 15 bar. The mixture was then heated to 130° C. while stirring at 500 rpm. On attainment of the reaction temperature, the pressure was adjusted to 36 bar with a mixture of 98% ethylene and 2% CO. Subsequently, 11.0 mg (0.049 mmol) of Pd(OAc)₂ and 29.9 mg (0.074 mmol) of ligand P̂O were dissolved in 5 ml of dichloromethane and injected into the reaction mixture via a pressure burette with the aid of a gas mixture of 98% ethylene and 2% CO, the total pressure was adjusted to 50 bar with a gas mixture of 98% ethylene and 2% CO, and the reaction mixture was stirred at 130° C. at constant pressure, which was regulated by supply of further gas mixture. After 2.3 hours, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

9.2 g of a copolymer of ethylene and CO were obtained. Thus, a TON of 188 g/mmol_{Pd} and a TOF of 81.6 g/(mmol_{Pd}×h) were attained.

Melting point: 120.7° C.

Viscosity (160.8° C.): 0.1662 Pa·s

IR: ν(CO)=1715 cm⁻¹

¹H NMR (300 MHz, C₆D₅Cl, 95° C.): δ=0.65-0.96 (9.259H), 0.91-1.11 (4.445H, 0.92-1.45 (477.67H), 1.48-1.61 (14.76H), 1.90-2.05 (3.372H), 2.18-2.32 (9.798H), 2.43-2.58 (2.403) 4.85-5.008 (2.253H), 5.38-5.42 (0.372H), 5.75-5.82 (1.000H) ppm.

The molar proportions of the monomers in the product were 97.7 mol % of ethylene and 2.3 mol % of CO.

The alternating fraction was 19.7 mol %.

From the proportion of double bonds in the ¹H NMR spectrum, an average molecular weight of Mₙ=2867 g/mol is calculated.

The level of branching was VG=5.91 branches per 1000 carbon atoms.

The semicrystallinity was χ=12.3%.

### Example 6

### Copolymerization of Ethylene and CO with a Catalyst Generated In Situ at an Ethylene/CO Ratio of 98:2 and a Reaction Temperature of 120° C.

A 300 ml stainless steel pressure reactor with a glass insert was initially charged with 95 ml of dichloromethane and the reactor was flooded with argon. Subsequently, the reactor was charged at room temperature with a mixture of 98% ethylene and 2% CO to a total pressure of 13 bar. The mixture was then heated to 120° C. while stirring at 500 rpm. On attainment of the reaction temperature, the pressure was adjusted to 35 bar with a mixture of 98% ethylene and 2% CO. Subsequently, 11.2 mg (0.05 mmol) of Pd(OAc)₂ and 30.4 mg (0.076 mmol) of ligand P̂O were dissolved in 5 ml of dichloromethane and injected into the reaction mixture via a pressure burette with the aid of a gas mixture of 98% ethylene and 2% CO, the total pressure was adjusted to 50 bar with a gas mixture of 98% ethylene and 2% CO, and the reaction mixture was stirred at 120° C. at constant pressure, which was regulated by supply of further gas mixture. After 2.5 hours, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

9.5 g of a copolymer of ethylene and CO were obtained. Thus, a TON of 190 g/mmol_{Pd} and a TOF of 76.0 g/(mmol_{Pd}×h) were attained.

Melting point: 119.3° C.

Viscosity (160.6° C.): 0.5199 Pa·s

IR: ν(CO)=1712 cm⁻¹

¹H NMR (300 MHz, C₆D₅Cl, 95° C.): δ=0.78-0.90 (8.415H), 1.02-1.15 (5.614H), 1.18-1.45 (691.10H), 1.51-1.63 (21.61H), 1.91-2.05 (3.963H), 2.15-2.30 (16.07H), 2.43-2.62 (6.375) 4.83-5.008 (2.364H), 5.39-5.41 (0.671H), 5.68-5.83 (1.001H) ppm.

The molar proportions of the monomers in the product were 97.1 mol % of ethylene and 2.9 mol % of CO.

The alternating fraction was 28.4 mol %.

From the proportion of double bonds in the ¹H NMR spectrum, an average molecular weight of Mₙ=3596 g/mol is calculated.

The level of branching was VG=2.44 branches per 1000 carbon atoms.

The semicrystallinity was χ=17.0%.

### Example 7

### Copolymerization of Ethylene and CO with a Catalyst Generated In Situ at an Ethylene/CO Ratio of 98:2 and a Reaction Temperature of 105° C.

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 15 bar. The mixture was then heated to 105° C. while stirring at 500 rpm. Subsequently, 11.5 mg (0.051 mmol) of Pd(OAc)₂ and 30.2 mg (0.075 mmol) of ligand P̂O were dissolved in 5 ml of dichloromethane and injected into the reaction mixture via a pressure burette with the aid of a gas mixture of 98% ethylene and 2% CO, the total pressure was adjusted to 50 bar with a gas mixture of 98% ethylene and 2% CO, and the reaction mixture was stirred at 105° C. at constant pressure, which was regulated by supply of further gas mixture. After 3.5 hours, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

18.1 g of a copolymer of ethylene and CO were obtained. Thus, a TON of 355 g/mmol_{Pd} and a TOF of 101 g/(mmol_{Pd}×h) were attained.

Melting point: 120.8° C.

Viscosity (160° C.): 2.692 Pa·s IR: ν(CO)=1716 cm⁻¹

¹H NMR (300 MHz, C₆D₅Cl, 95° C.): δ=0.81-0.95 (7.645H), 1.00-1.10 (5.060H), 1.14-1.45 (721.54H), 1.48-1.65 (26.36H), 1.83-2.08 (3.979H), 2.15-2.30 (16.38H), 2.40-2.65 (4.713H, 4.85-4.95 (1.316H), 4.98-5.03 (0.574H), 5.30-5.45 (0.868H), 5.70-5.86 (0.999H) ppm.

The molar proportions of the monomers in the product were 97.4 mol % of ethylene and 2.6 mol % of CO.

The alternating fraction was 22.34 mol %.

From the proportion of double bonds in the ¹H NMR spectrum, an average molecular weight of Mₙ=4114 g/mol is calculated.

The level of branching was VG=1.81 branches per 1000 carbon atoms.

The semicrystallinity was χ=3.9%.

### Example 8

### Copolymerization of Ethylene and CO with a Catalyst Generated In Situ at an Ethylene/CO Ratio of 98:2 and a Reaction Temperature of 100° C.

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 16 bar. The mixture was then heated to 100° C. while stirring at 500 rpm. Subsequently, 11.3 mg (0.05 mmol) of Pd(OAc)₂ and 30.4 mg (0.076 mmol) of ligand P̂O were dissolved in 5 ml of dichloromethane and injected into the reaction mixture via a pressure burette with the aid of a gas mixture of 98% ethylene and 2% CO, the total pressure was adjusted to 50 bar with a gas mixture of 98% ethylene and 2% CO, and the reaction mixture was stirred at 100° C. at constant pressure, which was regulated by supply of further gas mixture. After 3.0 hours, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

9.9 g of a copolymer of ethylene and CO were obtained. Thus, a TON of 198 g/mmol_{Pd} and a TOF of 66 g/(mmol_{Pd}×h) were attained.

Melting point: 122.2° C.

Viscosity (160.5° C.): 6.979 Pa·s

IR: ν(CO)=1707 cm⁻¹

¹H NMR (300 MHz, C₆D₅Cl, 95° C.): δ=0.97-1.05 (1.294H), 1.21-1.29 (1.094H), 1.30-1.58 (198.67H), 1.60-1.78 (4.950H), 1.91-2.05 (3.079H), 2.05-2.20 (0.682H), 2.28-2.42 (3.882H), 2.52-2.69 (0.999H), 4.98-5.16 (0.306H), 5.45-5.59 (0.0503H), 5.84-5.96 (1.105H) ppm.

The molar proportions of the monomers in the product were 97.8 mol % of ethylene and 2.2 mol % of CO.

The alternating fraction was 20.7 mol %.

From the proportion of double bonds in the ¹H NMR spectrum, an average molecular weight of Mₙ=8647 g/mol is calculated.

The level of branching was VG=2.08 branches per 1000 carbon atoms.

The semicrystallinity was χ=18.0%.

### Example 9

### Copolymerization of Ethylene and CO with a Catalyst Generated In Situ at an Ethylene/CO Ratio of 98:2 and a Reaction Temperature of 95° C.

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 16 bar. The mixture was then heated to 95° C. while stirring at 500 rpm. Subsequently, 11.3 mg (0.05 mmol) of Pd(OAc)₂ and 30.3 mg (0.075 mmol) of ligand P̂O were dissolved in 5 ml of dichloromethane and injected into the reaction mixture via a pressure burette with the aid of a gas mixture of 98% ethylene and 2% CO, the total pressure was adjusted to 50 bar with a gas mixture of 98% ethylene and 2% CO, and the reaction mixture was stirred at 95° C. at constant pressure, which was regulated by supply of further gas mixture. After 3 hours, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

5.8 g of a copolymer of ethylene and CO were obtained. Thus, a TON of 116 g/mmol_{Pd} and a TOF of 38.7 g/(mmol_{Pd}×h) were attained.

Melting point: 126.0° C.

Viscosity (160° C.): 13.24 Pa·s

IR: ν(CO)=1713 cm⁻¹

¹H NMR (300 MHz, C₆D₅Cl, 95° C.): δ=0.79-0.95 (22.32H), 1.05-1.18 (19.27H), 1.19-1.42 (3920.66H), 1.47-1.62 (145.19H), 1.78-1.83 (55.57H), 1.90-2.05 (15.36H), 2.10-2.30 (118.82H), 2.41-2.62 (42.76H), 4.85-4.98 (2.514H), 4.99-5.02 (0.762H), 5.38-5.44 (2.443H), 5.75-5.81 (1.011H) ppm.

The molar proportions of the monomers in the product were 96.4 mol % of ethylene and 3.6 mol % of CO.

The alternating fraction was 26.5 mol %.

From the proportion of double bonds in the ¹H NMR spectrum, an average molecular weight of Mₙ=12572 g/mol is calculated.

The level of branching was VG=1.68 branches per 1000 carbon atoms.

### Example 10

### Copolymerization of Ethylene and CO with a Catalyst Generated In Situ at an Ethylene/CO Ratio of 98:2 and a Total Pressure of 30 Bar

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 5 bar. The mixture was then heated to 110° C. while stirring at 500 rpm. Subsequently, 11.2 mg (0.05 mmol) of Pd(OAc)₂ and 30.2 mg (0.075 mmol) of ligand P̂O were dissolved in 5 ml of dichloromethane and injected into the reaction mixture via a pressure burette with the aid of a gas mixture of 98% ethylene and 2% CO, the total pressure was adjusted to 30 bar with a gas mixture of 98% ethylene and 2% CO, and the reaction mixture was stirred at 110° C. at constant pressure, which was regulated by supply of further gas mixture. After 1.75 hours, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

8.3 g of a copolymer of ethylene and CO were obtained. Thus, a TON of 166 g/mmol_{Pd} and a TOF of 94.9 g/(mmol_{Pd}×h) were attained.

Melting point: 122.09° C.

Viscosity (160° C.): 1.302 Pa·s

IR: ν(CO)=1716 cm′

¹H NMR (300 MHz, C₆D₅Cl, 95° C.): δ=0.88-0.95 (15.64H), 1.03-1.54 (916.36H), 1.90-2.05 (4.260H), 2.22-2.26 (9.891H), 2.41-2.62 (1.976H), 4.85-5.01 (2.501H), 5.38-5.44 (0.845H), 5.75-5.81 (1.001H) ppm.

The molar proportions of the monomers in the product were 98.8 mol % of ethylene and 1.2 mol % of CO.

The alternating fraction was 16.7 mol %.

From the proportion of double bonds in the ¹H NMR spectrum, an average molecular weight of Mₙ=4035 g/mol is calculated.

The level of branching was VG=6.47 branches per 1000 carbon atoms.

### Example 11

### Copolymerization of Ethylene and CO with a Catalyst Generated In Situ at an Ethylene/CO Ratio of 98:2 and a Total Pressure of 40 Bar

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 10 bar. The mixture was then heated to 110° C. while stirring at 500 rpm. Subsequently, 11.3 mg (0.05 mmol) of Pd(OAc)₂ and 31.1 mg (0.077 mmol) of ligand P̂O were dissolved in 5 ml of dichloromethane and injected into the reaction mixture via a pressure burette with the aid of a gas mixture of 98% ethylene and 2% CO, the total pressure was adjusted to 40 bar with a gas mixture of 98% ethylene and 2% CO, and the reaction mixture was stirred at 110° C. at constant pressure, which was regulated by supply of further gas mixture. After 2.15 hours, the reactor was cooled down to 25° C. and the pressure was released cautiously. The reaction mixture obtained was cautiously filtered and the solid residue washed with dichloromethane. Subsequently, the residue was dried under high vacuum at approx. 0.02 mbar for 16 hours.

8.1 g of a copolymer of ethylene and CO were obtained. Thus, a TON of 162 g/mmol_{Pd} and a TOF of 75.3 g/(mmol_{Pd}×h) were attained.

Melting point 125.8° C.

Viscosity (160° C.): 1.608 Pa·s

IR: ν(CO)=1714 cm⁻¹

¹H NMR (300 MHz, C₆D₅Cl, 95° C.): δ=0.82-1.11 (9.270H), 1.17-1.29 (12.06H), 1.30-1.60 (731.93H), 1.62-1.83 (86.33H), 2.10-2.20 (8.255H), 2.27-2.48 (22.01H), 2.58-2.75 (9.205H), 5.00-5.20 (2.00H), 5.49-5.60 (0.640H), 5.82-6.10 (0.999H) ppm.

The molar proportions of the monomers in the product were 96.6 mol % of ethylene and 3.4 mol % of CO.

The alternating fraction was 29.5 mol %.

From the proportion of double bonds in the ¹H NMR spectrum, an average molecular weight of Mₙ=4847 g/mol is calculated.

The level of branching was VG=3.17 branches per 1000 carbon atoms.

In Examples 1 to 11, TOFs at least a factor of 3 greater than the TOFs achieved in the literature with the same catalyst system for the ethylene-CO copolymer having the lowest CO content were achieved (2.82 g/(mmol_{Pd}×h) for an ethylene-CO copolymer with 6 mol % of CO in Organometallics 2009, 6994).

### Example 12

### Copolymerization of Ethylene and CO with a Complex Catalyst at an Ethylene/CO Ratio of 98:2

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 15 bar. The mixture was then heated to 110° C. while stirring at 500 rpm, in the course of which the total pressure in the reactor rose to 22.5 bar. On attainment of the reaction temperature, 10.7 mg (0.016 mmol) of [Pd(dcpOEt)(P̂O)] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 1.6 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

3.7 g of a copolymer of ethylene and CO were obtained. Thus, a TON of 231 g/mmol_{Pd} and a TOF of 145 g/(mmol_{Pd}×h) were attained.

Melting point: 125.67° C.

Viscosity (160.1° C.): 0.5622 Pa·s

IR: ν(CO)=1711 cm⁻¹

¹H NMR (300 MHz, C₆D₅Cl, 95° C.): δ=0.78-1.03 (10.65H), 1.03-1.16 (7.978H), 1.16-1.45 (861.87H), 1.45-1.69 (37.35H), 1.88-2.07 (3.712H), 2.07-2.37 (23.87H), 2.39-2.67 (8.734H), 4.86-5.05 (2.038H), 5.31-5.51 (0.810H), 5.67-5.86 (1.000H) ppm.

The molar proportions of the monomers in the product were 96.7 mol % of ethylene and 3.3 mol % of CO.

The alternating fraction was 26.8 mol %.

From the proportion of double bonds in the ¹H NMR spectrum, an average molecular weight of Mₙ=4870 g/mol is calculated.

The level of branching was VG=3.47 branches per 1000 carbon atoms.

### Example 13

### Copolymerization of Ethylene and CO with a Complex Catalyst at an Ethylene/CO Ratio of 98:2

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 15 bar. The mixture was then heated to 110° C. while stirring at 500 rpm. On attainment of the reaction temperature, 7.7 mg (0.011 mmol) of [Pd(dcpOEt)(P̂O)] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 2.4 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

5.57 g of a copolymer of ethylene and CO were obtained. Thus, a TON of 506 g/mmol_{Pd} and a TOF of 211 g/(mmol_{Pd}×h) were attained.

Melting point: 119.6° C.

Viscosity (160° C.): 0.432

IR: ν(CO)=1716 cm⁻¹

¹H NMR (300 MHz, C₆D₅Cl, 95° C.): δ=0.78-0.99 (17.85H), 1.00-1.10 (9.256H), 1.16-1.44 (1504.53H), 1.46-1.65 (43.10H), 1.80-2.03 (5.775H), 2.10-2.04 (26.88H), 2.41-2.58 (8.586H), 4.83-4.95 (2.169H), 4.98-5.04 (0.780H), 5.33-5.43 (0.889H), 5.63-5.90 (1.002H) ppm.

The molar proportions of the monomers in the product were 97.9 mol % of ethylene and 2.1 mol % of CO.

The alternating fraction was 24.2 mol %.

From the proportion of double bonds in the ¹H NMR spectrum, an average molecular weight of Mₙ=7579 g/mol is calculated.

The level of branching was VG=4.80 branches per 1000 carbon atoms.

### Example 14

### Copolymerization of Ethylene and CO with a Complex Catalyst at an Ethylene/CO Ratio of 98:2

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 16 bar. The mixture was then heated to 110° C. while stirring at 500 rpm. On attainment of the reaction temperature, 5.7 mg (0.0083 mmol) of [Pd(dcpOEt)(P̂O)] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 3.2 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

4.15 g of a copolymer of ethylene and CO were obtained. Thus, a TON of 500 g/mmol_{Pd} and a TOF of 156 g/(mmol_{Pd}×h) were attained.

Melting point: 126.2° C.

Viscosity (160° C.): 1.188 Pa·s

IR: ν(CO)=1715 cm⁻¹

¹H NMR (300 MHz, C₆D₅Cl, 95° C.): δ=0.80-0.95 (7.645H), 1.01-1.10 (5.060H), 1.12-1.45 (721.54H), 1.48-1.66 (26.36H), 1.83-2.08 (3.979H), 2.12-2.34 (16.38H), 2.39-2.62 (4.713H), 4.84-4.95 (1.316H), 4.96-5.02 (0.574H), 5.30-5.48 (0.868H), 5.70-5.87 (0.999H) ppm.

The molar proportions of the monomers in the product were 97.4 mol % of ethylene and 2.6 mol % of CO.

The alternating fraction was 22.3 mol %.

From the proportion of double bonds in the ¹H NMR spectrum, an average molecular weight of Mₙ=4114 g/mol is calculated.

The level of branching was VG=1.81 branches per 1000 carbon atoms.

The semicrystallinity was χ=3.9%.

The comparison with the literature (Organometallics 2005(24), 2755) shows that, with the same catalyst system, Examples 12 to 14 achieve TOFs greater than the TOFs achieved in the literature for the ethylene-CO copolymer having the lowest CO content (134 g/(mmol_{Pd}×h) for an ethylene-CO copolymer having 35.2 mol % of CO), even though the catalyst concentration is one order of magnitude lower than in the literature (0.072 to 0.13 mmol/l in Examples 12 to 14 compared to 1.15 mmol/l in the literature).

### Example 15

### Copolymerization of Ethylene and CO with a Complex Catalyst at an Ethylene/CO Ratio of 98:2

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 15 bar. The mixture was then heated to 110° C. while stirring at 500 rpm. On attainment of the reaction temperature, 4.6 mg (0.0067 mmol) of [Pd(dcpOEt)(P̂O)] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 4.75 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

1.65 g of a copolymer of ethylene and CO were obtained. Thus, a TON of 246 g/mmol_{Pd} and a TOF of 51.8 g/(mmol_{Pd}×h) were attained.

Melting point: 116.5° C.

Viscosity (160.1° C.): 1.623 Pa·s

IR: ν(CO)=1705 cm⁻¹

¹H NMR (300 MHz, C₆D₅Cl, 95° C.): δ=0.79-0.92 (8.240H), 1.01-1.13 (6.725H), 1.14-1.44 (1000.90H), 1.45-1.65 (51.39H), 1.75-1.85 (4.161H), 1.90-2.09 (4.553H), 2.13-2.30 (37.41H), 2.41-2.60 (7.441H), 4.81-4.96 (1.785H), 4.97-5.02 (0.645H), 5.30-5.46 (0.448H), 5.70-5.85 (1.001H) ppm.

The molar proportions of the monomers in the product were 96.1 mol % of ethylene and 3.9 mol % of CO.

The alternating fraction was 16.6 mol %.

From the proportion of double bonds in the ¹H NMR spectrum, an average molecular weight of Mₙ=5689 g/mol is calculated.

The level of branching was VG=1.87 branches per 1000 carbon atoms.

### Example 16

### Copolymerization of Ethylene and CO with a Complex Catalyst at an Ethylene/CO Ratio of 98:2

A 300 ml stainless steel pressure reactor with a glass insert was initially charged with 100 ml of dichloromethane and the reactor was flooded with argon. Subsequently, the reactor was charged at room temperature with a mixture of 98% ethylene and 2% CO to a total pressure of 15 bar. The mixture was then heated to 110° C. while stirring at 500 rpm. On attainment of the reaction temperature, 3.6 mg (0.0052 mmol) of [Pd(dcpOEt)(P̂O)] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 17.6 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

1.14 g of a copolymer of ethylene and CO were obtained. Thus, a TON of 219 g/mmol_{Pd} and a TOF of 12.5 g/(mmol_{Pd}×h) were attained.

Melting point: 119.8° C.

Viscosity (160° C.): 1.227 Pa·s

IR: ν(CO)=1711 cm⁻¹

¹H NMR (300 MHz, C₆D₅Cl, 95° C.): δ=0.78-0.95 (9.439H), 1.04-1.15 (7.831H), 1.16-1.45 (1145.55H), 1.48-1.70 (68.99H), 1.88-2.08 (5.439H), 2.10-2.38 (53.11H), 2.40-2.65 (11.27H), 4.83-4.95 (2.020H), 4.99-5.04 (0.732H), 5.70-5.90 (1.002H) ppm.

The molar proportions of the monomers in the product were 95.3 mol % of ethylene and 4.7 mol % of CO.

The alternating fraction was 17.5 mol %.

From the proportion of double bonds in the ¹H NMR spectrum, an average molecular weight of Mₙ=9488 g/mol is calculated.

The level of branching was VG=3.12 branches per 1000 carbon atoms.

### Example 17

### Homopolymerization of Ethylene and Subsequent Copolymerization of Ethylene and CO with a Complex Catalyst at an Ethylene/CO Ratio of 98:2 (See Also Example 12)

A 300 ml stainless steel pressure reactor with a glass insert was initially charged with 100 ml of dichloromethane and the reactor was flooded with argon. Subsequently, the reactor was charged at room temperature with ethylene to a total pressure of 11 bar. The mixture was then heated to 110° C. while stirring at 1000 rpm. On attainment of the reaction temperature, the pressure was adjusted to 40 bar with ethylene. Subsequently, 10.9 mg (0.016 mmol) of [Pd(dcpOEt)(P̂O)] were dissolved in 5 ml of dichloromethane and injected into the reaction mixture via a pressure burette with the aid of a positive pressure of ethylene. Subsequently, the total pressure was adjusted to 50 bar with ethylene and the reaction mixture was stirred at 110° C. at constant pressure, which was regulated by supplying further ethylene, until 800 standard litres of ethylene had been metered in (10 min). Then the gas was switched and a mixture of 98% ethylene and 2% CO was supplied to keep the pressure constant. After a further 90 minutes, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

11.2 g of a copolymer of ethylene and CO were obtained. Thus, a TON of 700 g/mmol_{Pd} and a TOF of 420 g/(mmol_{Pd}×h) were attained.

Melting point: 125.5

Viscosity (160° C.): 1.192 Pa·s

IR: ν(CO)=1718 cm⁻¹

¹H NMR (300 MHz, C₆D₅Cl, 95° C.): δ=0.77-0.99 (7.354H), 0.99-1.18 (6.404H), 1.18-1.48 (657.81H), 1.48-1.71 (10.41H), 1.90-2.11 (2.847H), 2.15-2.33 (1.567H), 2.44-2.53 (0.221H), 5.86-5.05 (2.036H), 5.34-5.46 (0.293H), 5.68-5.87 (1.000H) ppm.

The molar proportions of the monomers in the product were 99.7 mol % of ethylene and 0.3 mol % of CO.

The alternating fraction was 12.4 mol %.

From the proportion of double bonds in the ¹H NMR spectrum, an average molecular weight of

Mₙ=4158 g/mol is calculated.

The level of branching was VG=3.30 branches per 1000 carbon atoms.

In comparison to Example 12, a TOF almost 3 times higher was attained in this example (420 compared to 145 g/(mmol_{Pd}×h) in Example 12) by charging the reactor with ethylene rather than an ethylene-CO mixture at the start of the reaction.

### Example 18

### Terpolymerization of Ethylene, CO and 1-Hexene with a Complex Catalyst

A 300 ml stainless steel pressure reactor with a glass insert was initially charged with a mixture of 50 ml of dichloromethane and 50 ml of freshly distilled 1-hexene, and the reactor was flooded with argon. Subsequently, the reactor was charged at room temperature with a mixture of 98% ethylene and 2% CO to a total pressure of 10.2 bar. The mixture was then heated to 110° C. while stirring at 500 rpm, in the course of which the total pressure in the reactor rose to 17.4 bar. On attainment of the reaction temperature, the pressure was adjusted to 30.3 bar with a mixture of 98% ethylene and 2% CO. Then 14.4 mg (0.02 mmol) of [Pd(dcpOEt)(P̂O)] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 2 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

22.5 g of a terpolymer of ethylene, CO and 1-hexene were obtained.

Melting point: 109.91° C.

The melting range already begins at <25° C.

Viscosity in Pa·s (temperature): 0.613 (110° C.), 0.493 (120° C.), 0.404 (130° C.), 0.332 (140° C.), 0.273 (150° C.), 0.229 (160° C.).

IR: ν(CO)=1715 cm⁻¹

NMR (300 MHz, C₆D₅Cl, 95° C.): δ=0.76-1.02 (35.48H), 1.02-1.45 (964.501H), 1.45-1.70 (19.38H), 1.89-2.10 (7.871H), 2.14-2.34 (9.878H), 2.40-2.60 (2.293H), 4.75 (bs, 0.453H), 4.86-5.03 (2.464H), 5.32-5.47 (1.628H), 5.69-5.86 (1.000H) ppm.

The molar proportions of the monomers in the product were 94.5 mol % of ethylene, 4.3 mol % of 1-hexene and 1.3 mol % of CO.

The alternating fraction was 18.8 mol %.

From the proportion of double bonds in the ¹H NMR spectrum, an average molecular weight of Mₙ=3256 g/mol is calculated.

The level of branching was VG=16.63 branches per 1000 carbon atoms.

According to GPC (150° C., 1,2,4-trichlorobenzene, calibrated against polystyrene), the product has a number-average molecular weight Mₙ=3770 g/mol and a polydispersity index PDI=2.53.

### Example 19

### Terpolymerization of Ethylene, CO and 1-Hexene with a Complex Catalyst

A 300 ml stainless steel pressure reactor with a glass insert was initially charged with a mixture of 50 ml of dichloromethane and 50 ml of freshly distilled 1-hexene, and the reactor was flooded with argon. Subsequently, the reactor was charged at room temperature with a mixture of 98% ethylene and 2% CO to a total pressure of 10 bar. The mixture was then heated to 110° C. while stirring at 500 rpm. On attainment of the reaction temperature, the pressure was adjusted to 30 bar with a mixture of 98% ethylene and 2% CO. Then 14.3 mg (0.021 mmol) of [Pd(dcpOEt)L] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, until 2.5 standard litres of the gas mixture had been metered in (0.42 hour). After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

3.8 g of a terpolymer of ethylene, CO and 1-hexene were obtained.

Melting point: 112.43° C.

The melting range already begins at ≦50° C.

Viscosity in Pa·s (temperature): 0.875 (110° C.), 0.685 (120° C.), 0.546 (130° C.), 0.443 (140° C.), 0.363 (150° C.), 0.301 (160° C.).

IR: ν(CO)=1711 cm′

NMR (300 MHz, C₆D₅Cl, 95° C.): δ=0.76-1.02 (26.48H), 1.02-1.45 (767.337H), 1.45-1.70 (24.91H), 1.89-2.10 (5.845H), 2.14-2.34 (15.47H), 2.40-2.60 (7.287H), 4.75 (bs, 0.343H), 4.86-5.03 (2.074H), 5.32-5.47 (1.315H), 5.69-5.86 (0.999H) ppm.

The molar proportions of the monomers in the product were 93.5 mol % of ethylene, 3.7 mol % of 1-hexene and 2.8 mol % of CO.

The alternating fraction was 32.0 mol %.

From the proportion of double bonds in the ¹H NMR spectrum, an average molecular weight of =3282 g/mol is calculated.

The level of branching was VG=14.60 branches per 1000 carbon atoms.

According to GPC (150° C., 1,2,4-trichlorobenzene, calibrated against polystyrene), the product has a number-average molecular weight Mₙ=4580 g/mol and a polydispersity index PDI=2.41.

### Example 20

### Terpolymerization of Ethylene, CO and Styrene with a Complex Catalyst

A 300 ml stainless steel pressure reactor with a glass insert was initially charged with a mixture of 50 ml of dichloromethane and 50 ml of styrene, and the reactor was flooded with argon. Subsequently, the reactor was charged at room temperature with a mixture of 98% ethylene and 2% CO to a total pressure of 12 bar. The mixture was then heated to 110° C. while stirring at 500 rpm. On attainment of the reaction temperature, the pressure was adjusted to 30 bar with a mixture of 98% ethylene and 2% CO. Then 14.4 mg (0.021 mmol) of [Pd(dcpOEt)L] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, for 2 hours. After the reaction time was complete, the reactor was cooled down to 25° C. and the pressure was released cautiously. The reaction mixture obtained was cautiously filtered and the solid residue washed with dichloromethane. Subsequently, the residue was dried at 60° C. under high vacuum at approx. 0.02 mbar for 24 hours.

15.4 g of a terpolymer of ethylene, CO and styrene were obtained.

IR: ν(CO)=1717 cm⁻¹

NMR (300 MHz, C₆D₅Cl, 95° C.): δ=0.68-1.06 (4.997H), 1.06-1.49 (336.70H), 1.49-1.86 (23.88H), 1.93-2.15 (3.492H), 2.15-2.41 (10.83H), 2.63-2.78 (4.795H), 2.78-2.89 (1.200H), 4.92-5.11 (1.000H), 5.43-5.75 (0.227H), 5.75-5.91 (0.459H), 6.08-6.30 (1.226H), 6.30-6.48 (1.304H), 6.84-6.89 (6.568H), 6.89-7.58 (37.77H) ppm.

The molar proportions of the monomers in the product were 93.7 mol % of ethylene, 2.5 mol % of styrene and 3.8 mol % of CO.

The alternating fraction was 30.7 mol %.

From the proportion of double bonds in the ¹H NMR spectrum, an average molecular weight of Mₙ=1590 g/mol is calculated.

The level of branching was VG=3.88 branches per 1000 carbon atoms.

Melting point: 112.54° C.

The melting range already begins at ≦60° C.

Viscosity in Pa·s (temperature): 1.269 (110° C.), 1.021 (120° C.), 0.8791 (130° C.), 0.7344 (140° C.), 0.6906 (150° C.), 0.5585 (160° C.).

According to GPC (150° C., 1,2,4-trichlorobenzene, calibrated against polystyrene), the product has a number-average molecular weight Mₙ=3870 g/mol and a polydispersity index PDI=1.45.

### Example 21

### Terpolymerization of Ethylene, CO and Styrene with a Complex Catalyst

A 300 ml stainless steel pressure reactor with a glass insert was initially charged with a mixture of 50 ml of dichloromethane and 50 ml of styrene, and the reactor was flooded with argon. Subsequently, the reactor was charged at room temperature with a mixture of 98% ethylene and 2% CO to a total pressure of 11.7 bar. The mixture was then heated to 110° C. while stirring at 500 rpm. On attainment of the reaction temperature, the pressure was adjusted to 30 bar with a mixture of 98% ethylene and 2% CO. Then 14.5 mg (0.021 mmol) of [Pd(dcpOEt)L] were dissolved in 5 ml of dichloromethane and injected into the reaction mixture via a pressure burette with the aid of a gas mixture of 98% ethylene and 2% CO. Subsequently, the total pressure was adjusted to 50 bar with a gas mixture of 98% ethylene and 2% CO, and the reaction mixture was stirred at 110° C. at constant pressure, which was regulated by supplying further gas mixture, until 2.5 standard litres of the gas mixture had been metered in (0.65 hour). After the reaction time was complete, the reactor was cooled down to 25° C. and the pressure was released cautiously. The reaction mixture obtained was cautiously filtered and the solid residue washed with dichloromethane. The volatile constituents of the filtrate were removed by distillation under reduced pressure. 3.5 g of a terpolymer of ethylene, CO and styrene were obtained.

Melting point: 112.68° C.

The melting range already begins at ≦60° C.

Viscosity in Pa·s (temperature): 0.6902 (110° C.), 0.573 (120° C.), 0.4704 (130° C.), 0.3942 (140° C.), 0.3303 (150° C.), 0.323 (160° C.).

IR: ν(CO)=1716 cm⁻¹

NMR (300 MHz, C₆D₅Cl, 95° C.): δ=0.73-1.03 (5.347H), 1.03-1.52 (447.19H), 1.52-1.82 (26.68H), 1.94-2.13 (2.564H), 2.13-2.41 (15.48H), 2.41-2.61 (4.241H), 2.61-2.77 (1.264H), 4.90-5.09 (0.999H), 5.42-5.50 (0.0863H), 5.73-5.91 (0.467H), 6.11-6.27 (1.120H), 6.32-6.47 (1.171H), 6.47-6.82 (3.522H), 6.89-7.58 (37.04H) ppm.

The molar proportions of the monomers in the product were 94.5 mol % of ethylene, 1.8 mol % of styrene and 3.7 mol % of CO.

The alternating fraction was 21.5 mol %.

From the proportion of double bonds in the ¹H NMR spectrum, an average molecular weight of Mₙ=2261 g/mol is calculated.

The level of branching was VG=4.71 branches per 1000 carbon atoms.

According to GPC (150° C., 1,2,4-trichlorobenzene, calibrated against polystyrene), the product has a number-average molecular weight Mₙ=3420 g/mol and a polydispersity index PDI=1.63.

### Comparison:

Examples 3 to 21 give further embodiments of the process according to the invention.

1. A process for preparing an olefin-CO copolymer, comprising the steps of:
providing a reactor;
charging the reactor with a gaseous olefin and with CO, such that there is a first pressure p1 in the reactor;
reacting olefin with CO in the presence of a catalyst in the reactor;
wherein
prior to the reaction either no CO is present in the reactor or the volume ratio of gaseous olefin to CO is ≧90:10
and gaseous olefin and CO are metered in at least intermittently during the reaction, with an average over time of the volume ratio of the gaseous olefin metered in to CO metered in of ≧90:10.

2. The process according to claim 1, wherein the pressure in the reactor during the reaction is in the range from ≧80% of p1 to ≦120% of p1.

3. The process according to claim 1, wherein a pressure drop which occurs during the reaction is balanced out by feeding further gaseous olefin and CO into the reactor, and wherein the average over time of the volume ratio of the further gaseous olefin fed in to the further CO fed in is ≧90:10.

4. The process according to claim 1, wherein the catalyst comprises palladium.

5. The process according to claim 1, wherein the catalyst comprises an anionic bidentate ligand comprising a phosphorus atom bridged to an oxygen anion over at least two and a maximum of four further atoms.

6. The process according to claim 1, wherein the reaction of the olefin with CO takes place in the presence of a further olefin.

7. The process according to claim 1, wherein the reaction of the olefin with CO is preceded by a homopolymerization of the olefin or a copolymerization of a plurality of olefins in the reactor.

8. The process according to claim 1, wherein the pressure p1 is ≧20 bar to ≦300 bar.

9. The process according to claim 1, wherein the reaction is performed at a temperature of ≧90° C. to ≦150° C.

10. The process according to claim 1, wherein the catalyst is injected at a temperature of ≧90° C. to ≦150° C. into the reactor containing gaseous olefin or a mixture of gaseous olefin and CO.

11. An olefin-CO copolymer obtained by the process according to claim 1, wherein the content of CO incorporated into the polymer is ≦5 mol % based on all the monomers incorporated and the copolymer has an alternating fraction of ≦32.5 mol %.

12. The olefin-CO copolymer according to claim 11 having a number-average molecular weight Mₙ of ≦15 000 g/mol.

13. A polyol compound obtained by reducing the olefin-CO copolymer according to claim 11.

14. A polyamine and/or polyamine-polyalcohol compound obtained by reductively aminating the olefin-CO copolymer according to claim 11.

15. A method for the preparation of a polyurethane and/or polyurea polymer comprising utilizing the olefin-CO copolymer according to claim 11.

16. A method comprising utilizing the olefin-CO copolymer according to claim 11 as polymer additive.

17. A method for the preparation of a polyurethane and/or polyurea polymer comprising utilizing the polyol compound according to claim 13.

18. A method comprising utilizing the polyol compound according to claim 13 as polymer additive.

19. A method for the preparation of a polyurethane and/or polyurea polymer comprising utilizing the polyamine and/or polyamine-polyalcohol compound according to claim 14.

20. A method comprising utilizing the polyamine and/or polyamine-polyalcohol compound according to claim 14 as polymer additive.
